(19) United States
(12) Patent Application Publication
(10) Pub. No.: US 2006/0012650 A1
(43) Pub. Date: Jan. 19, 2006

(54) Liquid-supplying member, liquid-injection apparatus, mounting method, fluid-carrying tube, and manufacturing method of fluid-carrying tube

(75) Inventors: Atsushi Kobayashi, Nagano-ken (JP); Munehide Kanaya, Nagano-ken (JP); Izumi Nozawa, Nagano-ken (JP); Yoshiharu Aruga, Nagano-ken (JP); Kazuyuki Saito, Nagano-ken (JP); Natsuki Uemura, Nagano-ken (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/105,276

(22) Filed: Apr. 12, 2005

(30) Foreign Application Priority Data
Apr. 12, 2004 (JP) JP 2004-117300
May 27, 2004 (JP) JP 2004-157105
Apr. 8, 2005 (JP) JP 2005-111867
Apr. 8, 2005 (JP) JP 2005-111868

(51) Int. Cl. B41J 2/175

(52) U.S. Cl. 347/85

(57) ABSTRACT

A connection part is attached to an end of a liquid delivery tube, the connection part being provided with a flow path for changing the flowing direction of a liquid. A method for attaching the connection part to the liquid delivery tube comprises the steps of: preparing a pin having a leading end portion of substantially the same section as that of the flow path of the liquid delivery tube and an arcuate portion which curves in an arc from the leading end portion so as to have a substantially constant section; inserting the leading end portion of the pin into the flow path from at least one end of the liquid delivery tube; placing dies so as to enclose at least one end of the liquid delivery tube; forming the connection part by outsert molding from resin which fills the dies in which the liquid delivery tube and the pin are placed; and extracting the pin from the liquid delivery tube in a direction along the arcuate shape of the pin after removal of the dies from the liquid delivery tube and the connection part.

### CROSS REFERENCE TO THE RELATED APPLICATION

The present application claims the benefit of priority from Japanese Patent Applications Nos. 2004-117300 filed on Apr. 12, 2004, 2004-157105 filed on May 27, 2004, 2005-111867 filed on Apr. 8, 2005 and 2005-111868 filed on Apr. 8, 2005, the disclosures of which are incorporated herein by reference.

### BACKGROUND OF THE INVENTION

1. Field of the Invention

The present invention relates to a liquid supplying member, a liquid ejecting apparatus, an attaching method, a liquid delivery tube and a liquid delivery tube production method. More particularly, the invention relates to a liquid supplying member having flexibility and including a flow path which extends between both longitudinal ends thereof and through which a liquid flows, a liquid ejecting apparatus, an attaching method, a liquid delivery tube and a liquid delivery tube production method.

2. Description of Related Art

One known form of liquid ejecting apparatus is an ink jet recording apparatus. An ink jet recording apparatus is formed such that, while ink droplets being ejected from a recording head provided for a carriage, the carriage is moved along a guide member, thereby forming dots on a recording medium, for recording.

Such an ink jet recording apparatus has a plurality of ink cartridges in a main body frame and these cartridges connect to the carriage through an ink supplying tube. Through this ink supplying tube, inks are supplied to a recording head such as disclosed in, for example, Japanese Published Unexamined Patent Applications Nos. 2003-320680 and 2000-168099.

For example, in the ink jet recording apparatus according to Japanese Published Unexamined Patent Application No. 2003-320680, the ink supplying tube includes five elongated, elastic members formed from elastomer, two film members and two connection parts. Specifically, the ink supplying tube is formed such that the five elastic members are equally spaced in parallel with one another and the two film members are adhered by melting with the elastic members sandwiched between them, whereby four flow paths are formed. The ink supplying tube includes the connection parts which are attached to both ends of the elastic members and have communication holes that communicate with the four flow paths. Thus, the ink supplying tube has a flat long shape and flexibility.

In the ink supplying tube of such a structure, the connection parts formed at both ends thereof are respectively connected to the carriage and the ink cartridges, so that inks can be supplied from the ink cartridges to the recording head attached to the carriage. When the carriage moves during recording, the ink supplying tube can bend to follow the movement of the carriage.

As a method for producing a member for use in an ink jet printer, there are known the two-color injection molding and the insert molding such as disclosed, for example, in Japanese Published Unexamined Patent Application No. 11-157092.

As a liquid delivery tube for delivering a liquid which is one example of the above member, there is known a liquid delivery tube having flexibility over the entire length thereof and provided with a plurality of flow paths such as disclosed, for example, in Japanese Published Unexamined Patent Application No. 58-41180 (FIG. 4) and Japanese Published Unexamined Utility Model Application No. 6-746 (FIG. 1). One known method for producing such a liquid delivery tube is the extrusion molding such as disclosed, for example, in Japanese Published Examined Patent Application No. 7-2362 (FIGS. 1 and 8).

### DESCRIPTION OF THE INVENTION

Problems that the Invention is to Solve

The ink supplying tube of Japanese Published Unexamined Patent Application No. 2003-320680, thus, has the unintegrally formed connection parts inserted into both ends thereof. The ink supplying tube of Japanese Published Unexamined Patent Application No. 2000-168099 has an unintegrally formed connection part joined to its end by heat adhesion. This leads to an increased number of parts and therefore increased man-hour for assembling. Similarly to the two-color injection molding or the insert molding disclosed in Japanese Published Unexamined Patent Application No. 11-157092, these ink supplying tubes present another drawback in which when forming the connection part at the ends of the ink supplying tube by outsert molding with dies, the resin, from which the connection parts are to be made, penetrates into the flow paths of the ink supplying tube.

The liquid delivery tube disclosed in Japanese Published Unexamined Patent Application No. 58-41180 (see FIG. 4) is in the form of a tube formed by connecting single cylindrical tubes by plate-like coupling members. This liquid delivery tube has revealed the problem that since it has plate-like coupling members, the number of coupling members increases as the number of flow path increases and as a result, the tube becomes large as a whole.

The liquid delivery tube disclosed in Japanese Published Unexamined Utility Model Application No. 6-746 ( FIG. 1) is provided with a plurality of flow paths without use of plate-like coupling members. This publication only mentions that the liquid delivery tube is integrally molded but does not teach how to mold it. In addition, the liquid delivery tube shown in the drawings of this publication has the problem that since the resin forming the flow paths is thin, the liquid is likely to evaporate outwardly from the flow paths when passing through the flow paths.

In the production method disclosed in Japanese Published Examined Patent Application No. 7-2362 (FIGS. 1 and 8), the liquid delivery tube having a plurality of flow paths is extruded by blowing gas from holes provided for the area where the flow paths are to be formed. This production method presents the disadvantage that since the sectional shape of the whole tube is determined by changing the pressure of the gas blown from one certain hole, the outside shape of the tube cannot be stably fixed.

Means of Solving the Problems

The foregoing problems can be solved by an attaching method according to a first aspect of the invention. This method is for attaching a connection part to at least one of both longitudinal ends of a liquid delivery tube having flexibility and including a flow path which extends between the longitudinal ends and through which a liquid flows, the method comprising the steps of: preparing a pin having substantially the same section as that of the flow path of the liquid delivery tube; inserting the leading end portion of the pin into the flow path from at least one end of the liquid delivery tube; placing dies so as to enclose the at least end of the liquid delivery tube through which the leading end portion of the pin is inserted; forming the connection part by outsert molding from resin which fills the dies in which the liquid delivery tube and the pin are placed; and extracting the pin from the liquid delivery tube after removal of the dies from the liquid delivery tube and the connection part. In the above method, when forming the connection part so as to enclose the end of the liquid delivery tube, a flow path connected to the flow path of the liquid delivery tube can be formed in the connection part, while preventing the resin from penetrating into the flow path of the liquid delivery tube.

The above attaching method may further include a melting-adhesion step in which after the extraction step, a sealing member is melted and adhered to seal a hole through which the pin has been extracted, thereby forming the flow path in the connection part. This enables provision of a desired flow path in the connection part formed by outsert molding.

The above attaching method may further include an extrusion step in which the liquid delivery tube is formed by extrusion molding before the insertion step, the liquid delivery tube having a hollow inner layer portion which defines the flow path and an outer layer portion which has a melting point equal to or lower than that of the inner layer portion and covers the inner layer portion with the same material as contained in the connection part. And, in the formation step, the outsert molding by use of the resin may be carried out at a temperature equal to or lower than the melting point of the inner layer portion. This arrangement increases adhesibility between the liquid delivery tube and the connection part, while preventing deformation of the inner layer portion of the liquid delivery tube caused by heat.

In the above attaching method, the liquid delivery tube may include a plurality of flow paths. In the preparation step, a coupling pin constituted by a plurality of pins connected and arranged in parallel may be prepared, and in the insertion step, the leading end portions of the plurality of pins which constitute the coupling pin may be inserted into the flow paths, respectively, of the liquid delivery tube. This arrangement facilitates formation of the connection part at an end of the liquid delivery tube having a plurality of flow paths, the connection part having a plurality of flow paths which are connected to the flow paths of the liquid delivery tube.

In the above attaching method, the pin has an arcuate portion which curves in an arc from its leading end portion so as to have a substantially constant section, and the pin may be extracted in a direction along the arcuate shape of the arcuate potion. This makes it possible to provide the flow path for changing the flowing direction of the liquid in the connection part.

In the above attaching method, the liquid delivery tube may be formed from a thermoplastic elastomer. In addition, the liquid delivery tube may be formed by extrusion molding.

In the above attaching method, the connection part may be formed from polypropylene. The connection part may be formed from polyethylene. Alternatively, the connection part may be formed from a thermoplastic elastomer.

According to a second aspect of the invention, there is provided a liquid supplying member having: a liquid delivery tube having flexibility and including a flow path which extends between both longitudinal ends thereof and through which a liquid flows; and a connection part provided at at least one of the ends of the liquid delivery tube and having a flow path one end of which is coupled to the flow path of the liquid delivery tube while the other end being connected to the outside, wherein the connection part has: (i) an integral main body portion having a groove coupled, at one end, to the flow path of the liquid delivery tube and opened at one face thereof and an outside-communicating portion which allows the other end of the groove to communicate with the outside; and (ii) a sealing member for sealing the open face of the groove, and wherein the groove, the sealing member and the outside-communicating portion define the flow path of the connection part. Thereby, an arrangement for connection to other flow paths can be easily obtained.

In the above liquid supplying member, the liquid delivery tube may have a plurality of flow paths and the connection part may have the same number of flow paths as the liquid delivery tube has, the flow paths of the connection part being connected to the plurality of flow paths of the liquid delivery tube, respectively. This makes it possible to supply a plural kinds of liquid from one end to the other end in the liquid supplying member.

In the above liquid supplying member, the outside-communicating portion of the connection part may include, in at least one of the plurality of flow paths, a penetrating flow path which is coupled to the other end of the groove and passes through the main body portion up to the rear of the open face of the groove. Additionally, the outside-communicating portions may respectively include, in the remaining ones of the plurality of flow paths, a coupling flow path for coupling the other end of the groove to the rear of the face in which the liquid delivery tube is disposed. Thereby, liquids can be allowed to flow between the connection part and the outside in different planes.

In the liquid supplying member, the liquid delivery tube may include a hollow inner layer portion defining the flow path; and an outer layer portion having a melting point equal to or lower than that of the inner layer portion and covering the inner layer portion with the same material as contained in the connection part. This increases the adhesibility between the liquid delivery tube and the connection part, while preventing the inner layer portion of the liquid delivery tube from being deformed by heat.

In the liquid supplying member, the connection part may further have a flow path for connecting the liquid delivery tube to the groove and the flow path may curve in an arc. With this arrangement, the flow path can be smoothly bent in an arc from the flow path of the liquid delivery tube within the connection part. Thereby, it can be connected to the outside in a direction perpendicular to the longitudinal direction of the liquid delivery tube, thereby ensuring improved sealing properties, while air bubbles contained in the liquid delivery tube are prevented from staying in the flow path of the connection part.

In the above liquid supplying member, the liquid delivery tube may be formed from a thermoplastic elastomer. In addition, the liquid delivery tube may be formed by extrusion molding.

In the above liquid supplying member, the connection part may be formed from polypropylene. The connection part may be formed from polyethylene. Alternatively, the connection part may be formed from a thermoplastic elastomer.

According to a third aspect of the invention, there is provided a liquid ejecting apparatus having: a liquid jet head for emitting a jet of liquid; liquid reservoir means for storing liquid; a liquid delivery tube having flexibility, for sending the liquid from the liquid reservoir means to the liquid jet head; and a connection part provided at at least one of both ends of the liquid delivery tube and having a flow path one end of which is coupled to a flow path of the liquid delivery tube while the other end being connected to the outside, wherein the connection part has: (i) an integral main body portion including (1) a groove which communicates, at one end, with the flow path of the liquid delivery tube and is opened at one face, and (2) an outside-communicating portion for making the other end of the groove communicate with the outside; and (ii) a sealing member for sealing the open face of the groove, and wherein the groove, the sealing member and the outside-communicating portion define the flow path of the connection part. With this arrangement, the third aspect has the same effect as the second aspect.

In the above liquid ejecting apparatus, the connection part may further have a flow path for connecting the liquid delivery tube to the groove and the flow path may curve in an arc. The liquid delivery tube may be formed from a thermoplastic elastomer. In addition, the liquid delivery tube may be formed by extrusion molding.

In the above liquid ejecting apparatus, the connection part may be formed from polypropylene. The connection part may be formed from polyethylene. Alternatively, the connection part may be formed from a thermoplastic elastomer.

According to a fourth aspect of the invention, there is provided a liquid supplying member having: a liquid delivery tube having flexibility and including a flow path which extends between both longitudinal ends thereof and through which a liquid flows; and a connection part formed by outsert molding at at least one of both ends of the liquid delivery tube and having a flow path one end of which is coupled to the flow path of the liquid delivery tube while the other end being connected to the outside, wherein the liquid delivery tube includes: a hollow inner layer portion defining the flow path; and an outer layer portion which has a melting point equal to or lower than that of the inner layer portion and covers the inner layer portion with the same material as contained in the connection part. With this arrangement, the inner layer portion of the liquid delivery tube can be prevented from being deformed by heat and the bondability between the liquid delivery tube and the connection part can be increased.

In the above liquid supplying member, the liquid delivery tube may have a plurality of flow paths and the connection part may have the same number of flow paths as the liquid delivery tube has, which are connected to the plurality of flow paths of the liquid delivery tube, respectively. This makes it possible to supply a plural kinds of liquid from one end to the other end in the liquid supplying member.

In the above liquid supplying member, the liquid delivery tube may be formed from a thermoplastic elastomer. In addition, the liquid delivery tube may be formed by extrusion molding.

In the above liquid supplying member, the connection part may be formed from polypropylene. The connection part may be formed from polyethylene. Alternatively, the connection part may be formed from a thermoplastic elastomer.

According to a fifth aspect of the invention, there is provided a liquid delivery tube formed by extruding a resin having flexibility, wherein a plurality of hollow flow paths defined by the resin are aligned in parallel, each allowing a fluid to flow therein, and wherein the thickness of the resin between every adjacent flow paths is less than the thickness of the resin between each flow path and the outer circumferential surface of the resin. Since the resin between the adjacent flow paths is thinner, vapors coming out from the adjacent flow paths offset each other, so that vapor can be prevented from escaping outwardly from the liquid delivery tube. In addition, thanks to the thinner resin between the adjacent flow paths, the liquid delivery tube can be miniaturized and bent into an arc having a small radius even though a plurality of flow paths are provided.

The above liquid delivery tube may further have a reinforcing layer for covering the outer circumferential surface with a material different from the material of the tube. This leads to an improvement in the performance of the liquid delivery tube.

In the liquid delivery tube, the sectional area of the flow paths may be 100 mm² or less per path. In the flow paths, a plurality of flow paths are aligned in parallel.

According to a sixth aspect of the invention, there is provided a method for producing a liquid delivery tube, the method comprising: a gas supplying step in which gas is supplied to the inside of a plurality of tubular projections provided for an extrusion core; an extrusion step in which an extruded tube is extruded by pouring a resin having flexibility into a resin flow path formed between the extrusion core and an extrusion die which surrounds the extrusion core, the extruded tube having flow paths each of which has an inner circumferential shape which coincides with the peripheral shape of each projection of the extrusion core in section perpendicular to an extruding direction, and the extruded tube having a peripheral shape which coincides with the inner circumferential shape of the extrusion die in section perpendicular to the extruding direction; and a sizing step in which gas is supplied to the inside of the flow path of the extruded tube which has been extruded and the extruded tube is elongated by making the extruded tube pass through a sizing die which has a smaller inner circumference than the inner circumference of the extrusion die in section perpendicular to the extruding direction, whereby the liquid delivery tube is reshaped. The outer circumference of the extruded tube is pressed against the inner circumference of the sizing die by applying gas pressure from the flow path, whereby stable reshaping can be ensured.

In the method for producing the liquid delivery tube, the sizing step may include a depressurization step for reducing pressure within the sizing die. This makes it possible to more reliably press the outer circumference of the extruded tube against the inner circumference of the sizing die.

According to the method for producing the liquid delivery tube, in the inner circumference of the sizing die, the thickness of the resin between every adjacent flow paths is less than the thickness of the resin between each flow path and the outer circumferential surface of the liquid delivery tube. In this arrangement, since the resin between the adjacent flow paths is thinner, vapors coming out from the adjacent flow paths offset each other, so that vapor can be prevented from escaping outwardly from the liquid delivery tube. In addition, thanks to the thinner resin between the adjacent flow paths, the liquid delivery tube can be miniaturized and bent into an arc having a small radius even though a plurality of flow paths are provided.

In the method for producing the liquid delivery tube, the extrusion step may include a step in which a reinforcing layer enclosing the outer circumferential surface of the extruded tube is formed by pouring a reinforcing resin different from said resin from the downstream side of a position where said resin is poured, when viewing in the extruding direction. This leads to an improvement in the performance of the liquid delivery tube.

The summary of the invention does not necessarily describe all necessary features of the present invention. The present invention may also be a sub-combination of the features described above.

### BRIEF DESCRIPTION OF THE DRAWINGS

FIG. 1 is a perspective view of an ink jet recording apparatus 1 according to one embodiment.

FIG. 2 is a front elevational view showing a first ink guide member 10 in the installed condition shown in FIG. 1.

FIG. 3 is a rear elevational view of the first ink guide member 10.

FIG. 4 is a top view of the first ink guide member 10.

FIG. 5 is a front elevational view of a second ink guide member 12 in the installed condition shown in FIG. 1.

FIG. 6 is a rear elevational view of the second ink guide member 12.

FIG. 7 is a top view of the second ink guide member 12.

FIG. 8 is a front elevational view of an ink feeding member 110.

FIG. 9 is an enlarged front elevational view of a cartridge-side connection part 13 shown in FIG. 8.

FIG. 10 is a rear elevational view of the cartridge-side connection part 13 when viewed from its back.

FIG. 11 is a sectional view of the cartridge-side connection part 13 taken along line B-B of FIG. 9.

FIG. 12 is an enlarged front elevational view of a carriage-side connection part 220 shown in FIG. 8.

FIG. 13 is a rear elevational view of the carriage-side connection part 220 when viewed from its back.

FIG. 14 is a sectional view of the carriage-side connection part 220 taken along line C-C of FIG. 12.

FIG. 15 is a schematic sectional view illustrating a method of attaching the carriage-side connection part 220 shown in FIG. 14 to an ink supplying tube 14.

FIG. 16 is a top view illustrating a condition where the cartridge-side connection part 13 of the ink feeding member 110 is connected to the first and second ink guide members 10, 12.

FIG. 17 is a sectional view of the ink supplying tube 14 taken along line A-A of FIG. 8.

FIG. 18 is a sectional view of the carriage-side connection part 220 according to another example taken along line C-C.

FIG. 19 is a schematic sectional view illustrating how to attach the carriage-side connection part 220 shown in FIG. 18 to the ink supplying tube 14.

FIG. 20 is a perspective view of a liquid delivery tube 500 according to another example.

FIG. 21 is a schematic side view of a manufacturing apparatus 600 for producing the liquid delivery tube 500 shown in FIG. 20.

FIG. 22 is a sectional view of an extrusion head portion 613 and an extrusion die portion 614, when they are vertically cut in an extruding direction.

FIG. 23 is an enlarged sectional view of the extrusion head portion 613 and the extrusion die portion 614 when they are horizontally cut.

FIG. 24 is an enlarged front elevational view showing the neighborhood of the extrusion die portion 614 when viewed from a downstream side in the extruding direction.

FIG. 25 is a sectional view of a sizing die 632 of a sizing system 630 when it is vertically cut in a longitudinal direction of the liquid delivery tube 500.

FIG. 26 is a sectional view of a liquid delivery tube 540 according to still another example.

FIG. 27 is a sectional view of a liquid delivery tube 550 according to still another example.

FIG. 28 is a sectional view of a liquid delivery tube 560 according to still another example.

### DETAILED DESCRIPTION OF THE INVENTION

The embodiments of the present invention will now be described in detail with reference to accompanying drawings, which do not intend to limit the scope of the present invention, but exemplify the invention. All of the features and the combinations thereof described in the embodiments are not necessarily essential to the invention.

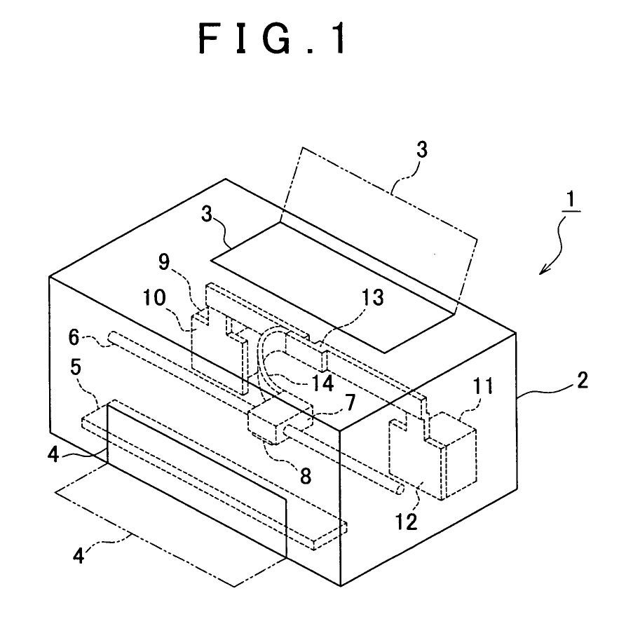

FIG. 1 is a perspective view schematically illustrating an ink jet recording apparatus 1 constructed according to one embodiment. As illustrated in FIG. 1, the ink jet recording apparatus 1, which is one example of liquid ejecting apparatus, includes a substantially rectangular parallel-piped frame 2. Disposed on the top face of the frame 2 is a paper feed tray 3. Disposed in front of the frame 2 is a catch tray 4. The paper feed tray 3 and the catch tray 4 are installed in the frame 2 in a collapsed manner, by means of a hinge structure (not shown).

A platen 5 extends in a longitudinal direction within the frame 2. A recording paper, which has been inserted into the frame 2 from the paper feed tray 3, is fed onto the platen 5 by a paper feed mechanism (not shown). The recording paper thus fed is ejected from the catch tray 4 to the outside of the frame 2.

A guide member 6 is disposed in parallel with the platen 5 within the frame 2. A carriage 7 movable along the guide member 6 is supported by the guide member 6 such that the guide member 6 passes through the carriage 7. Attached to the frame 2 is a carriage motor (not shown) to which the carriage 7 is drivingly coupled through a timing belt (not shown) wound around a pair of pulleys (not shown). This arrangement allows a driving force generated when the carriage motor is driven to be transmitted to the carriage 7 through the timing belt. The carriage 7 receives the driving force so that it reciprocates in parallel with the platen 5, being guided by the guide member 6 (in a main scan direction).

The carriage 7 is provided, at its underside (the face opposed to the platen 5), with a recording head 8 serving as a liquid jet head. The recording head 8 has a nozzle-formed face opposed to the recording paper. On the nozzle-formed face, six rows of nozzles (not shown), each row having n nozzles (n is a natural number), are formed. While six rows each composed of n nozzles are formed in the present embodiment for the sake of simplicity, the number of nozzles per row and the number of rows are not limited to this but may be varied arbitrarily.

Located at the left back of the inner space of the frame 2 shown in FIG. 1 is a first ink cartridge 9 to which a first ink guide member 10 is connected. Located at the right back of the inner space of the frame 2 is a second ink cartridge 11 to which a second ink guide member 12 is connected. The first and second ink guide members 10, 12 are for guiding inks stored in the first and second ink cartridges 9, 11, respectively. These ink guide members 10, 12 are connected, at the center of the inner space of the frame 2, to a cartridge-side connection part 13 of tube connection parts 100 described later.

An ink supplying tube 14 of an ink feeding member 110 having six flow paths is connected to the cartridge-side connection part 13. The other end of the ink supplying tube 14 is connected to the carriage 7 by a carriage-side connection part 220 described later. The cartridge-side connection part 13 feeds inks to the carriage 7 through the ink supplying tube 14, which inks have been sent from the first and second ink cartridges 9, 11, being guided by the first and second ink guide members 10, 12, respectively. More specifically, the inks stored in the first and second ink cartridges 9, 11 are respectively supplied to the recording head 8 by way of the first and second ink guide members 10, 12, the cartridge-side connection part 13, the ink supplying tube 14, the carriage-side connection part 220 and the carriage 7.

The first ink cartridge 9 of the present embodiment is equipped with ink packs (not shown) for storing black, cyanogen and magenta, respectively. The second ink cartridge 11 is equipped with ink packs (not shown) for storing yellow, light cyanogen and light magenta. Each ink pack is pressed by pressurized air which has been fed into the first and second ink cartridges 9, 11 from a booster pump (not shown) provided within the frame 2, so that inks are forcedly sent to the first and second ink guide members 10, 12.

Supplied to the recording head 8 are black, cyan and magenta from the first ink cartridge 9 and yellow, light cyan and light magenta from the second ink cartridge 11. The inks flowing into the recording head 8 are emitted in the form of ink droplets from the respective nozzles, being pressurized by a piezoelectric element (not shown), whereby dots are formed on the recording paper. Thus, the ink jet recording apparatus 1 makes the recording head 8 eject inks for recording data on the recording paper, while moving the carriage 7 along the guide member 6.

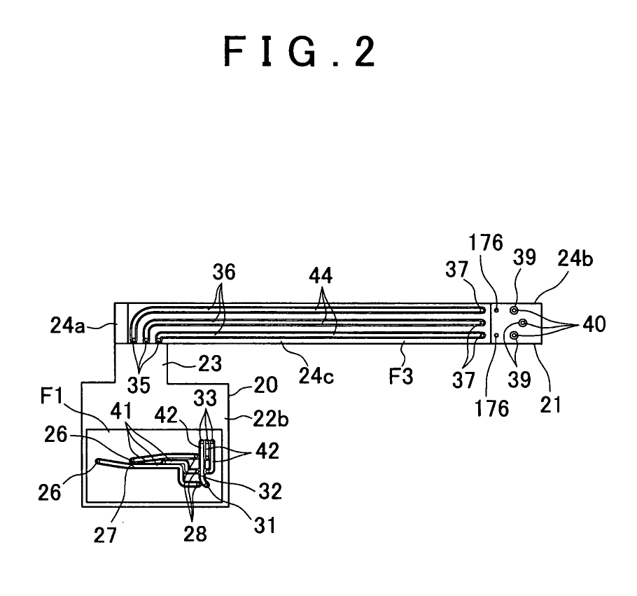

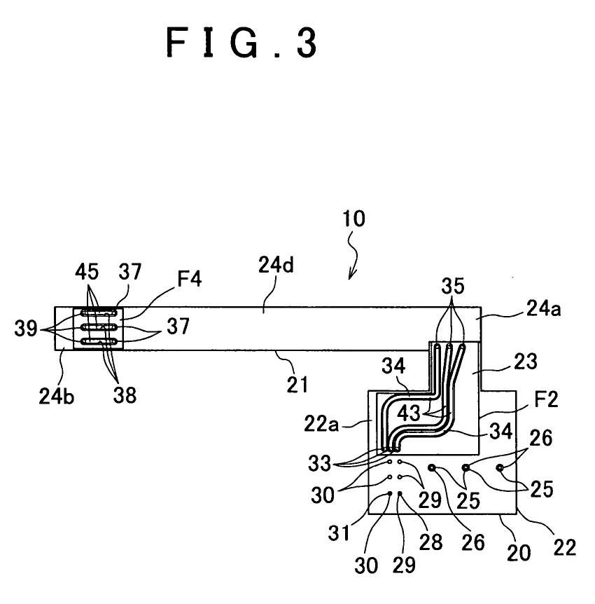

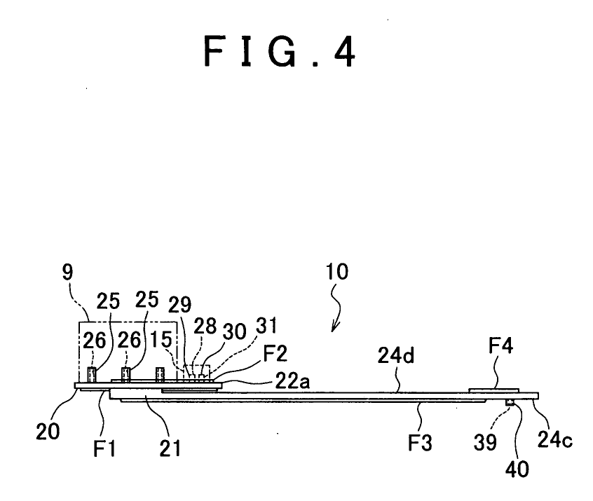

FIG. 2 is a front elevational view of the first ink guide member 10 in the installed condition shown in FIG. 1. FIG. 3 is a rear elevational view of the first ink guide member 10 in a like condition. FIG. 4 is a top view of the first ink guide member 10 in a like condition.

As shown in FIG. 2, the first ink guide member 10 is equipped with a connecting board 20 and an arm 21. The connecting board 20 is in the form of a rectangular board, and a fixing portion 23 is so formed as to upwardly extend from one side (upper side) of the connecting board 20. The arm 21 is in the form of a long board, and its proximal end portion 24a is secured to the fixing portion 23, while its leading end portion 24b being connected to the cartridge-side connection part 13. Thereby, the arm 21 is formed such that when the first ink guide member 10 is installed in the frame 2 (see FIG. 1), its leading end portion 24b projects toward the center of the inner space of the frame 2.

As shown in FIG. 3, three cylindrical cartridge connection parts 25 are projectingly formed on the rear face 22a of the connecting board 20. These cartridge connection parts 25 are for connection of their associated ink packs of the first ink cartridge 9 and are each provided with a lead-out hole 26. Each lead-out hole 26 runs through the connecting board 20, communicating with one end of its associated first groove 27 cut in the front face 22b.

Projectingly formed on the rear face 22a of the connecting board 20 are three cylindrical first valve connection parts 29 which are respectively equipped with a first communication hole 28. The first communication holes 28 of the first valve connection parts 29 run through the connecting board 20, each communicating with the other end of its associated first groove 27 cut in the front face 22b.

Further, three cylindrical second valve connection parts 30 are projectingly formed on the rear face 22a. The second valve connection parts 30 are each provided with a second communication hole 31. Each second valve communication hole 31 runs through the connecting board 20, communicating with one end of its associated second groove 32 formed in the front face 22b.

In the other end of each second groove 32, a third communication hole 33 is defined. Each third communication hole 33 runs through the connecting board 20, communicating with one end of its associated third groove 34 formed in the rear face 22a. Each third groove 34 extends with the other end located in the fixing portion 23 as shown in FIG. 3. Defined in the other end of each third groove 34 is a fourth communication hole 35.

Each fourth communication hole 35 runs through the fixing portion 23 and the arm 21 secured to the fixing portion 23, communicating with one end of its associated fourth groove 36 formed in the front face 24c of the arm 32. The fourth grooves 36 formed in the front face 24c of the arm 21 are each formed between the proximal end portion 24a and leading end portion 24b of the arm 21. In the other end of each fourth groove 36, a fifth communication hole 37 is defined. Each fifth communication hole 37 runs through the arm 21, communicating with one end of its associated fifth groove 38 formed in the rear face 24d. In the other end of each fifth groove 38, a sixth communication hole 39 is formed, which runs through the arm 21 up to the rear face 24d. Connection parts 40 project from the rear face 24d so as to enclose their associated sixth communication holes 39. The three connection parts 40 shown in FIG. 2 are arranged in a zigzag line. Positioning projections 176 are disposed in the rear face 24d, which project lower than the height of the connection parts 40.

A first film F1 is adhered by melting to the front face 22b of the connecting board 20 thus formed, such that the first and second grooves 27, 32 are sealed as shown in FIG. 2. A second film F2 is adhered by melting to the rear face 22a of the connecting board 20 so as to seal the third grooves 34 as shown in FIG. 3. Further, a third film F3 is adhered by melting to the front face 24c of the arm 21 so as to seal the fourth grooves 36. Further, a fourth film F4 is adhered by melting to the rear face 24d of the arm 21 so as to seal the fifth grooves 38.

The films F1 to F4 have a gas barrier function and seal the grooves such that the first film F1 and the first grooves 27 define first flow paths 41; the first film and the second grooves 32 define second flow paths 42; the second film F2 and the third grooves 34 define third flow paths 43; the third film F3 and the fourth grooves 36 define third flow paths 44; and the fourth film F4 and the fourth grooves 38 define fourth flow paths 45.

As indicated by two-dot chain line in FIG. 4, the three first valve connection parts 29 are respectively connected to their corresponding second valve connection parts 30 through a valve gear 15 on the rear face 22a of the connecting board 20. The valve gears 15 inhibit a reverse flow of ink toward the side of the first ink cartridge 9, which ink has been guided from the first ink cartridge 9.

The connecting board 20 is coupled to the first ink cartridge 9 such that the three cartridge connection parts 25 disposed on the rear face 22a of the connecting board 20 are respectively connected to the outlets of their associated ink packs provided for the first ink cartridge 9. Thereby, the inks stored in the ink packs of the first ink cartridge 9 are supplied to the cartridge-side connection part 13 through the first to fifth flow paths 41-45 of the first ink guide member 10.

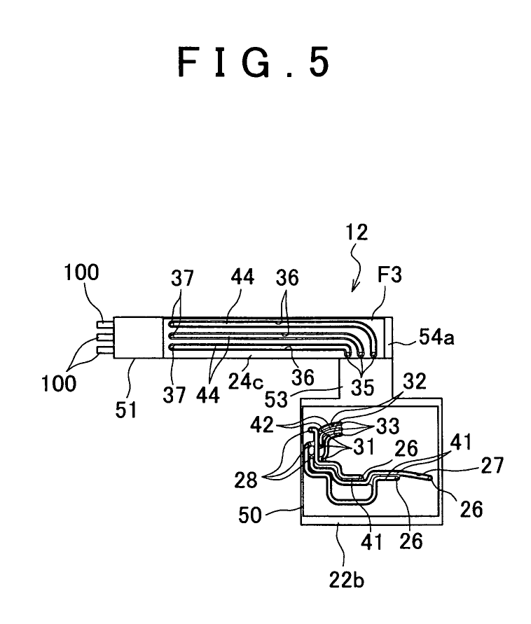

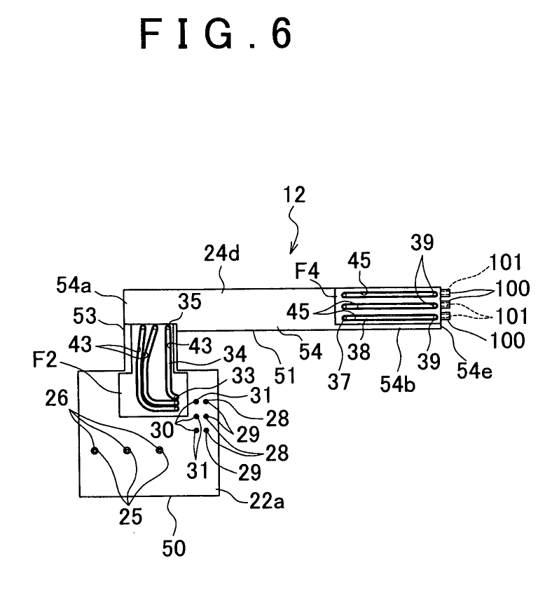

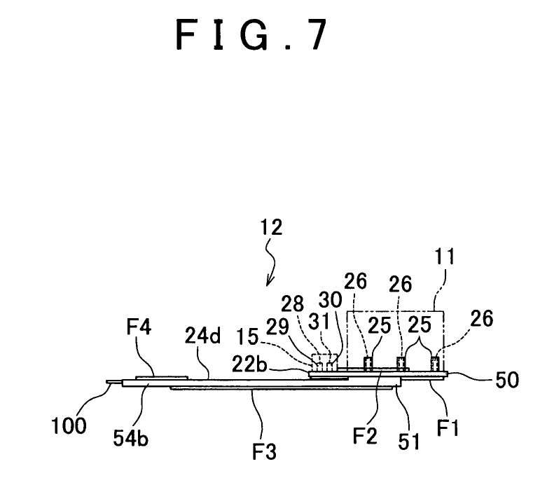

Next, reference is made to FIGS. 5 to 7 for describing the configuration of the second ink guide member 12 provided between the second ink cartridge 11 and the cartridge-side connection part 13. FIG. 5 is a front elevational view of the second ink guide member 12. FIG. 6 is a rear elevational view of the second ink guide member 12. FIG. 7 is a top view of the second ink guide member 12.

As shown in FIG. 5, the second ink guide member 12 includes a connecting board 50 and an arm 51. The connecting board 50 is in the form of a rectangular board, and a fixing part 43 is so formed as to extend upwardly from one side of the connecting board 50 in FIG. 5. The arm 51 is in the form of a long board and secured to the fixing part 53 at a proximal end portion 54a thereof. With this arrangement, a leading end portion 54b of the arm 51 extends to the center of the inner space of the frame 2, when the second ink guide member 12 is installed in the frame 2 (see FIG. 1).

As shown in FIGS. 6 to 7, three cylindrical tube connection parts 100 are projectingly arranged in parallel on a side face 54e located at the leading end portion 54b of the arm 51 of the second ink guide member 12. The tube connection parts 100 connect the second ink guide member 12 to the connection tube 13. The tube connection parts 100 each have a communication hole 101. The communication holes 101 communicate with the sixth communication holes 39, respectively, of the fourth flow paths 45. Thereby, in the present embodiment, the inks stored in the ink packs of the second ink cartridge 11 respectively flow from the first flow paths 41 to the valve gears 15 and the second to fifth flow paths 42, 43, 44, 45 in this order and then reach the tube connection parts 100.

Other flow paths of the second ink guide member 12 are the same as those of the first ink guide member 10 in configuration except the points described earlier. Therefore, the same reference numerals as of the constituents of the first ink guide member 10 are assigned to their corresponding parts of the second ink guide member 12 and a detailed description of them is skipped herein.

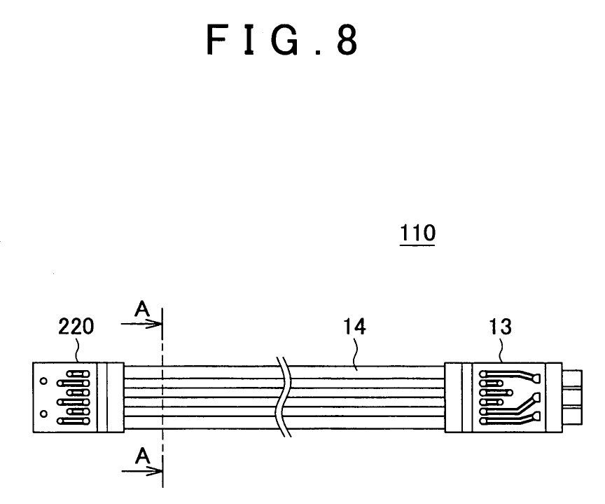

FIG. 8 is a front elevational view of the ink feeding member 110 and shows a condition where sealing members 140, 240 are eliminated, for illustrative purposes. As shown in FIG. 8, the ink feeding member 110 has an ink supplying tube 14 with flexibility including flow paths 141 which extend between both longitudinal ends of the ink supplying tube 14 and through which liquid flows; a cartridge-side connection part 13 formed at one end of the ink supplying tube 14; and a carriage-side connection part 220 formed at the other end of the same. The cartridge-side connection part 13 is connected to the first ink guide member 10 and the second ink guide member 12. The inks from the first and second ink guide members 10, 12 are guided to the flow paths 141 of the ink supplying tube 14. The carriage-side connection part 220 connects to the carriage 7. The inks from the flow paths 141 of the ink supplying tube 14 are guided to the recording head 8 provided for the carriage 7.

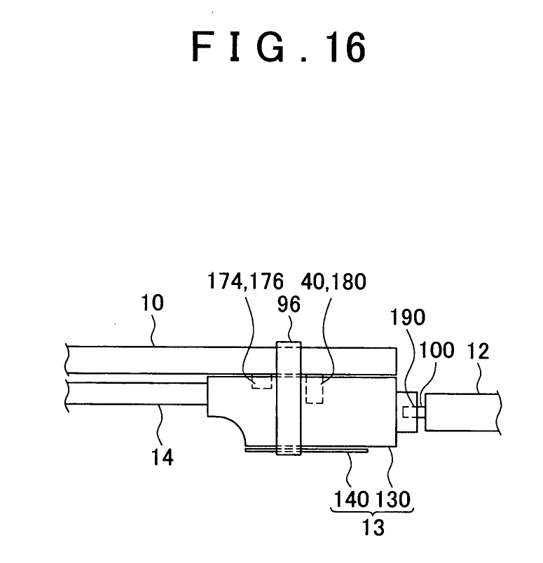

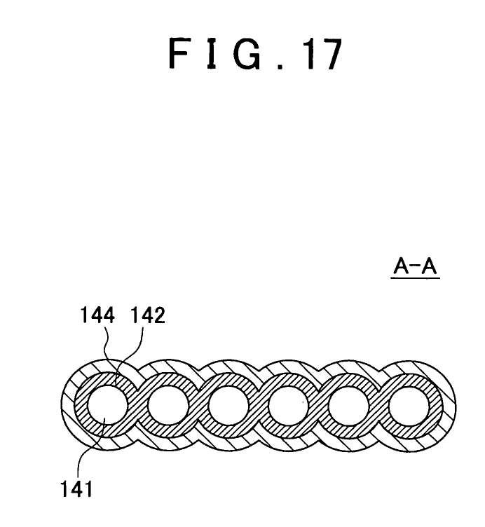

FIG. 17 is a sectional view of the ink supplying tube 14 taken along line A-A of FIG. 8. The ink feeding member 110 has six flow paths 141 which correspond to three types of ink from the first ink guide member 10 and another three types of ink from the second ink guide member 12. The cartridge-side connection part 13 and the carriage-side connection part 220 have the same number of flow paths which are connected to the plurality of flow paths 141 of the ink supplying tube 14 respectively. This enables feeding of a plurality of types of liquid from one end to the other in the ink feeding member 110. In addition, the ink supplying tube 14 has a hollow inner layer portion 142 defining the flow paths 141 and an outer layer portion 144 which has a melting point lower than that of the inner layer portion 142 and is formed from the same material as contained in the cartridge-side connection part 13 and the carriage-side connection part 220 so as to cover the inner layer portion 142. The inner layer portion 142 and the outer layer portion 144 will be later described in detail with reference to FIG. 16.

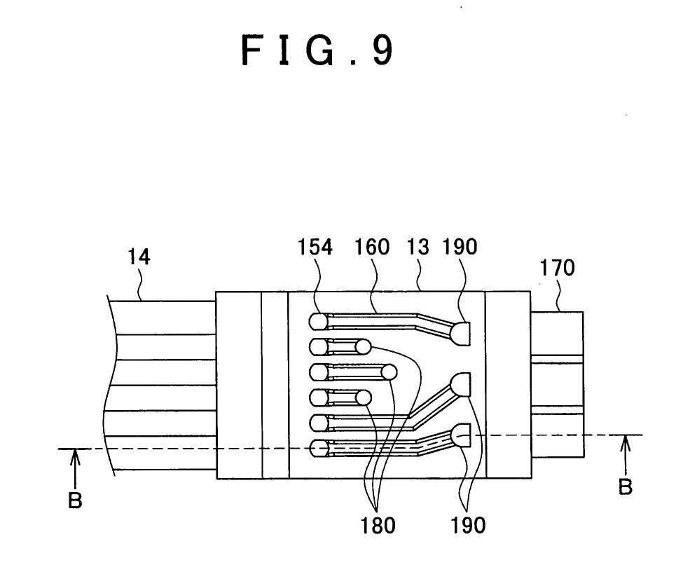

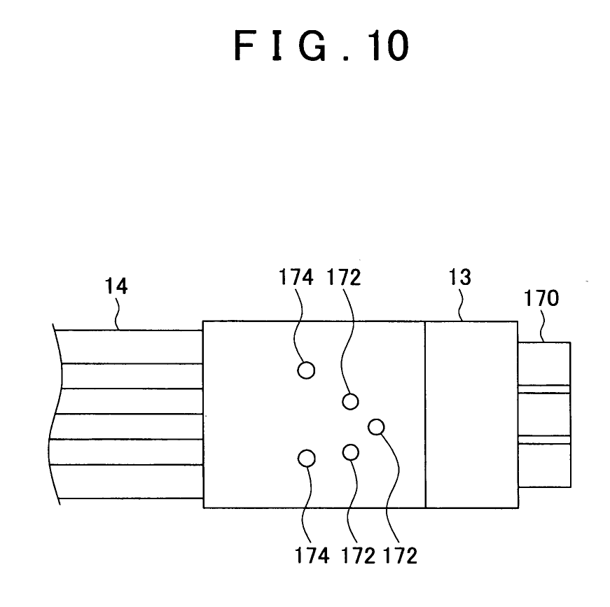

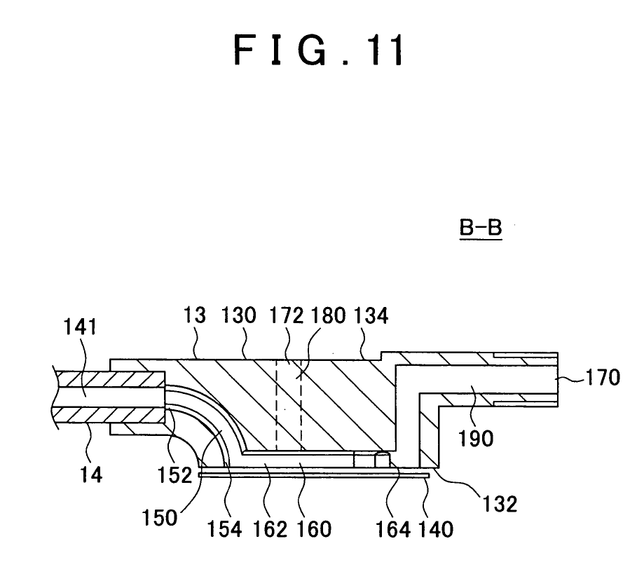

FIG. 9 is an enlarged front elevational view of the cartridge-side connection part 13 shown in FIG. 8. FIG. 10 is a rear elevational view of the cartridge-side connection part 13 when viewed from its back. FIG. 11 is a sectional view of the cartridge-side connection part 13 taken along line B-B of FIG. 9.

As shown in FIGS. 9 to 11, the cartridge-side connection part 13 includes a main body portion 130 integrally formed by outsert molding at an end of the ink supplying tube 14 and a sealing member 140 covering a front face 132 of the main body portion 130. The main body portion 130 of the cartridge-side connection part 13 has arcuate flow paths 150 which are coupled, at one end 152 thereof, to the flow paths 141 of the ink supplying tube 14 and curved in an arc; grooves 160 each of which communicates, at one end 162 thereof, with the other end 154 of its associated arcuate flow path 150 and is opened on the side of the front face 132; three outside-communicating portions 172 each of which allows the other end 164 of its associated groove 160 to communicate with the first ink guide member 10; and three outside-communicating portions 170 coupled to the second ink guide member 12. The sealing member 140 seals the grooves 160 of the main body portion 130 at the front face 132.

In three of the six flow paths, the outside-communicating portions 172 of the cartridge-side connection part 13 have penetrating flow paths 180 each of which is connected to the other end 164 of its associated groove 160 and extends from the front face 132 to the rear face 134 so as to pass through the main body portion 130. In each of the outside-communicating portions 172 of the cartridge-side connection part 13, the arcuate flow path 150, the groove 160, 140 and the penetrating flow path 180 define a flow path. As shown in FIG. 10, the open ends of the outside-communicating portions 172 are arranged in a staggered manner with respect to a widthwise direction. This arrangement leads to an improvement in the sealing of the flow paths when the outside-communicating portions 172 of the cartridge-side connection part 13 are connected to the first ink guide member 10.

In the remaining three flow paths, the outside-communicating portions 170 of the cartridge-side connection part 13 have coupling flow paths 190 each of which connects the other end 164 of its associated groove 160 to the rear (the right face in FIG. 11) of the face where the ink supplying tube 14 is disposed. In each of the outside-communicating portions 170 of the cartridge-side connection part 13, the arcuate flow path 150, the groove 160, the sealing member 140 and the coupling flow path 190 define a flow path. The rear face 134 of the main body portion 130 is provided with positioning recesses 174. The positioning recesses 174 come into engagement with the positioning projections 176 of the first ink guide member 10 respectively, thereby positioning the cartridge-side connection part 13 relative to the first ink guide member 10.

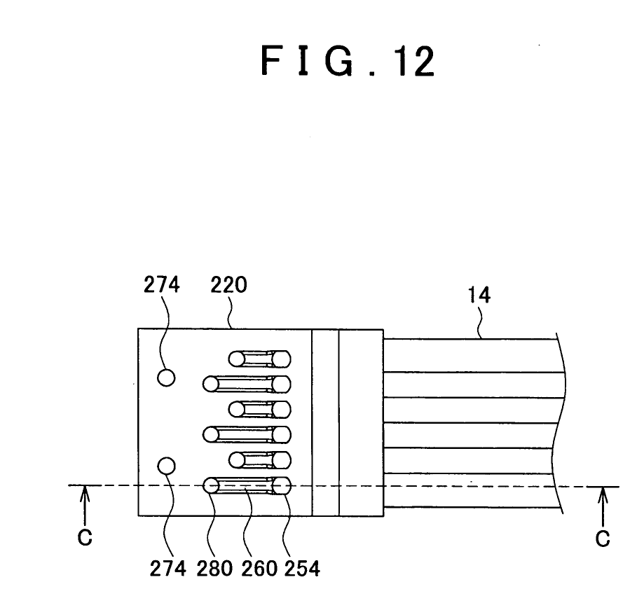

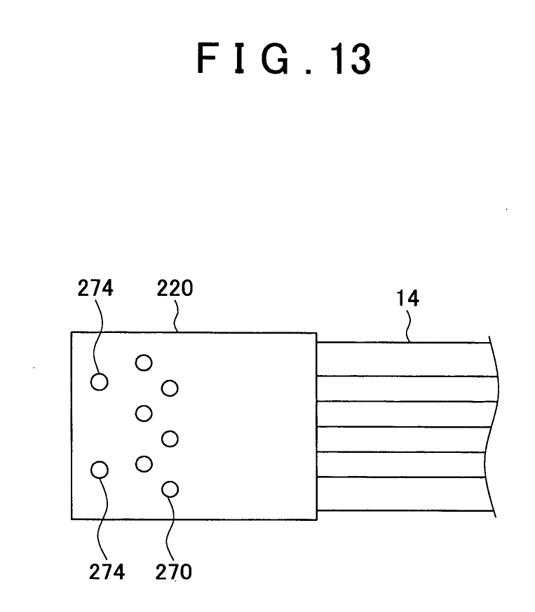

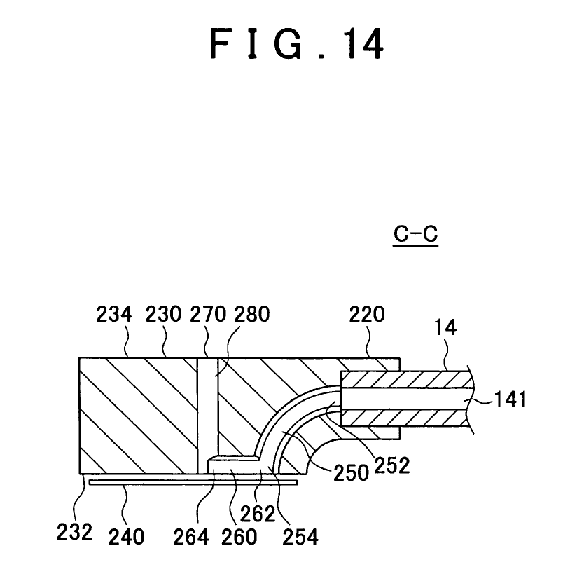

FIG. 12 is an enlarged front elevational view of the carriage-side connection part 220 shown in FIG. 8. FIG. 13 is a rear elevational view of the carriage-side connection part 220 when viewed from its back. FIG. 14 is a sectional view of the carriage-side connection part 220 taken along line C-C of FIG. 12.

As shown in FIGS. 12 to 14, the carriage-side connection part 220 has a main body portion 230 integrally formed by outsert molding at an end of the ink supplying tube 14 and a sealing member 240 covering the front face 232 of the main body portion 230, similarly to the cartridge-side connection part 13. The main body portion 230 of the carriage-side connection part 220 has arcuate flow paths 250 which are coupled to the flow paths 141 of the ink supplying tube 14 at one end 252 thereof and curved in an arc; grooves 260 each of which communicates with the other end of its associated arcuate flow path 250 at one end 262 thereof and is opened to the front face 232; and six outside-communicating portions 270 each of which allows communication between the other end 264 of its associated groove 260 and the carriage 7.

In each of the six flow paths, the outside-communicating portion 270 of the carriage-side connection part 220 communicates with the other end 264 of the groove 260 and has a penetrating flow path 280 which extends from the front face 232 to the rear face 234, passing through the main body portion 230. In each of the outside-communicating portions 270 of the carriage-side connection part 220, the arcuate flow path 250, the groove 260, the sealing member 240 and the penetrating flow path 280 define a flow path. As shown in FIG. 13, the open ends of the outside-communicating portions 270 are arranged in a staggered manner with respect to a widthwise direction. This leads to an improvement in the sealing of the flow paths when the outside-communicating portions 270 of the carriage-side connection part 220 are connected to the carriage 7.

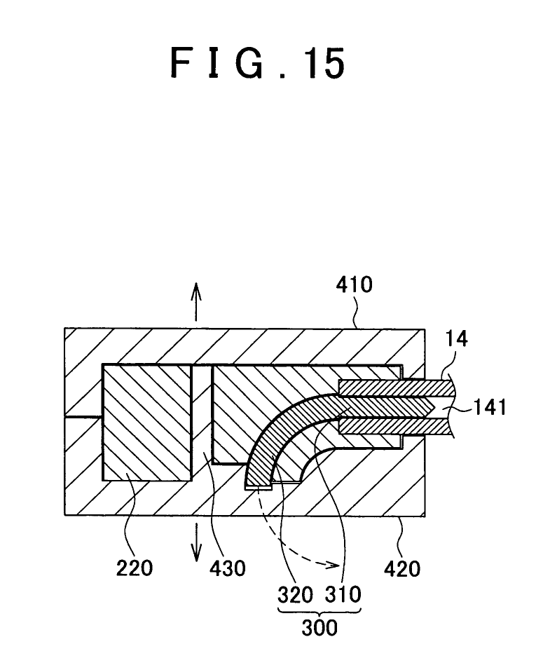

FIG. 15 is a schematic sectional view illustrating a method of attaching the carriage-side connection part 220 shown in FIG. 14 to the ink supplying tube 14. Since the method of attaching the main body portion 230 to the ink supplying tube 14 is the same, an explanation on it is skipped.

For attaching the carriage-side connection part 220 to the ink supplying tube 14, the ink supplying tube 14 having two layers, i.e., the inner layer portion 142 and the outer layer portion 144 is first formed by extrusion molding. In this case, it is preferable that the outer layer portion 144 be made from the same material as contained in the inner layer portion 142, the cartridge-side connection part 13 and the carriage-side connection part 220 and have a melting point lower than that of the inner layer portion 142. For instance, where at least one of the inner layer portion 142, the cartridge-side connection part 13 and the carriage-side connection part 220 is formed from an elastomer having flexibility and contains PP (polypropylene), polyolefin resin is used as the material of the outer layer portion 144. Examples of the polyolefin resin used for the outer layer portion 144 include PP. Where the elastomer of at least either the carriage-side connection part 220 or the inner layer portion 142 contains polyethylene, polyethylene may be used for the outer layer portion 144.

Metallic pins 300 are prepared. As shown in FIG. 15, each pin 300 includes: a leading end portion 310 having substantially the same section as the sealing member 140 of the ink supplying tube 14; and an arcuate portion 320 which curves in an arc from the leading end portion 310 so as to have a substantially constant section. In the pin 300 shown in FIG. 15, the arcuate portion 320 is larger in sectional area than the leading end portion 310. Therefore, even though the leading end portion 310 does not keep the shape of an arc defined by the arcuate portion 320 but extends straightly from the leading end of the arcuate portion 320, the leading end portion 310 can be taken out of the carriage-side connection part 220. The pin 300 is chamfered at the leading end of the leading end portion 310 for guiding. The leading end portion 310 of the pin 300 is inserted into each flow path 141 through one end of the ink supplying tube 14.

An upper die 410 and a lower die 420 are placed so as to enclose the end of the ink supplying tube 14 through which the leading end portions 310 of the pins 300 are inserted. In the case shown in FIG. 15, the upper die 410 and the lower die 420 are detachably fit together with a parting face defined by the face where the flow paths 141 of the ink supplying tube 14 are aligned in parallel. When these dies are fit, a cavity is created between the upper die 410 and the lower die 420, this cavity having the same outline as the carriage-side connection part 220. In this case, a flow path forming die 430 is incorporated in the lower die 420, for forming the grooves 260 and the penetrating flow paths 280. Further, the lower die 420 may be designed to have a recess for instance. In this case, the ends of the pins 300 may be inserted into the lower die 420, the ends being opposite to the leading end portions 310, and the pins 300 and the ink supplying tube 14 may be positioned relative to the lower die 420. In addition, as shown in FIG. 15, the leading end portion 310 of each pin 300 holds the ink supplying tube 14 between the upper die 410 and the lower die 420. This prevents leakage of the resin through the clearance between the upper and lower dies 410, 420 and the flexible ink supplying tube 14.

Next, the resin is injected into the upper die 410 and lower die 420 in which the ink supplying tube 14 and the pins 300 are placed, for forming the carriage-side connection part 220 by outsert molding. In this case, the resin is outsert-molded at a temperature which is equal to or higher than the melting point of the outer layer portion 144 of the ink supplying tube 14 and equal to or lower than the melting point of the inner layer portion 142. Since the melting point of the outer layer portion 144 is not higher than the melting point of the inner layer portion 142 , the outer layer portion 144 of the ink supplying tube 14 melts and adheres to the resin of the carriage-side connection part 220, while preventing deformation of the inner layer portion 142 caused by heat. Further, since the material of the outer layer portion 144 is contained in the material of the inner layer portion 142, the bondability between the inner layer portion 142 and the outer layer portion 144 can be increased.

After filling the dies with the resin and cooling the dies, the upper die 410 and the lower die 420 are separated by parallel displacement in the direction of the arrow of solid line shown in FIG. 15 and removed from the carriage-side connection part 220. Then, the pins 300 are extracted from the ink supplying tube 14 in a direction along the arcuate shape of the arcuate potion 320 (i.e., the direction of the arrow of broken line shown in FIG. 15). This has the effect that where the carriage-side connection part 220 is molded so as to enclose the end of the ink supplying tube 14, the arcuate flow paths 250 connected to the flow paths 141 of the ink supplying tube 14 can be formed in the carriage-side connection part 220, while preventing penetration of the resin into the flow paths 141 of the ink supplying tube 14.

After removal of the carriage-side connection part 220 from the upper die 410 and the upper die 410, the sealing member 240 is melted and adhered to the side from which the pins 300 have been extracted. Thanks to melting adhesion of the sealing member 240, the other ends 254 of the arcuate flow paths 250 of the carriage-side connection part 220 from which the pins 300 have been removed form the flow paths in association with the grooves 260 connected to the other ends 254. This enables provision of desired flow paths in the carriage-side connection part 220 formed by outsert molding.

In the above attaching method, a coupling pin, in which the same number of pins 300 as that of flow paths 141 of the ink supplying tube 14 are arranged in parallel and coupled, is prepared, and then, the leading end portions 310 of the pins 300 of the coupling pin may be inserted into the flow paths 141, respectively, of the ink supplying tube 14. This enables it to easily form the carriage-side connection part 220 at the end of the ink supplying tube 14 having the plurality of flow paths 141, the connection part 220 having the plurality of arcuate flow paths 250 connected to the flow paths 141.

FIG. 16 is a top view illustrating a condition where the cartridge-side connection part 13 of the ink feeding member 110 is connected to the first and second ink guide members 10, 12. By fitting the positioning projections 176 of the first ink guide member 10 in the positioning recesses 174 of the cartridge-side connection part 13, the first ink guide member 10 and the cartridge-side connection part 13 are positioned. In this condition, the connection parts 40 of the first ink guide member 10 are inserted into the penetrating flow paths 180 from the rear face of the cartridge-side connection part 13 so that the sixth communication holes 39 of the first ink guide member 10 are communicated with the flow paths of the cartridge-side connection part 13. In this case, three pairs of catch trays 40 and penetrating flow paths 180 are arranged in a staggered manner, thereby ensuring improved sealing properties. Further, the first ink guide member 10 and the cartridge-side connection part 13 are fixedly held by a belt 96. On the other hand, the tube connection parts 100 of the second ink guide member 12 are inserted into the coupling flow paths 190 from the side opposite to the ink supplying tube 14 of the cartridge-side connection part 13. This allows communication between the communication holes 101 of the second ink guide member 12 and the flow paths of the cartridge-side connection part 13. As a result, inks can flow between the first ink guide member 10 and the second ink guide member 12 in different planes of the cartridge-side connection part 13.

According to the attaching method of the present embodiment described earlier, where the cartridge-side connection part 13 and the carriage-side connection part 220 are formed by molding so as to enclose the ends of the ink supplying tube 14 respectively, flow paths connected to the flow paths 141 of the ink supplying tube 14 can be formed in the cartridge-side connection part 13 and in the carriage-side connection part 220, while preventing penetration of the resin into the flow paths 141 of the ink supplying tube 14.

In the ink feeding member 110 produced by the above attaching method, the flow paths can be smoothly bent in an arc from the flow paths 141 of the ink supplying tube 14 within the cartridge-side connection part 13, 220. Thereby, it can be connected to the first ink guide member 10 and the carriage 7 in a direction perpendicular to the longitudinal direction of the ink supplying tube 14, thereby ensuring improved sealing properties, while air bubbles contained in the ink supplying tube 14 are prevented from staying in the flow paths of the cartridge-side connection part 13 and the carriage-side connection part 220.

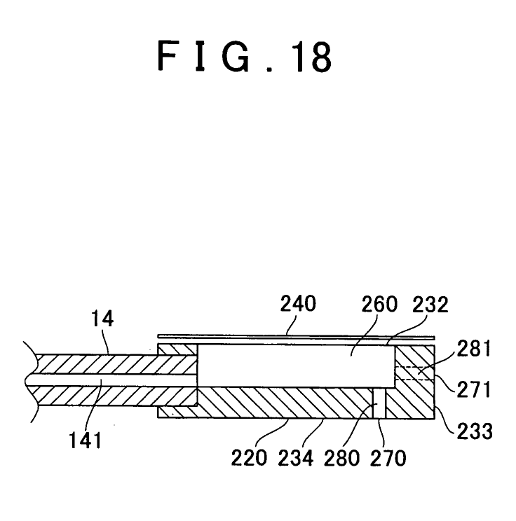

FIG. 18 shows a sectional view of the carriage-side connection part 220 according to another example, which is taken along line C-C similarly to FIG. 14. The same reference numerals as of the constituents of the carriage-side connection part 220 shown in FIG. 18 are assigned to the their corresponding parts and a description of them is skipped herein.

As shown in FIG. 18, the carriage-side connection part 220 has the main body portion 230 integrally formed by outsert molding at an end of the ink supplying tube 14 and the sealing member 240 covering the front face 232 of the main body portion 230. The main body portion 230 of the carriage-side connection part 220 has (i) the grooves 260 which are connected to the flow paths 141 of the ink supplying tube 14 at one end 252 thereof and opened at the front face 232 side and (ii) the six outside-communicating portions 270 each of which allows communication between the other end 264 of its associated groove 260 and the carriage 7. The sealing member 240 seals the front faces 232 of the grooves 260. That is, the carriage-side connection part 220 shown in FIG. 18 differs from the carriage-side connection part 220 shown in FIG. 14 in that the former does not have the arcuate flow paths 250.

In some (e.g., three) of the six flow paths, the outside-communicating portion 270 of the carriage-side connection part 220 is connected to the groove 260 and has a penetrating flow path 280 which extends from the front face 232 to the rear face 234, passing through the main body portion 230. In this case, in the outside-communicating portions 270 of the carriage-side connection part 220, the groove 260, the sealing member 240 and the penetrating flow path 280 constitute the flow path. In some (e.g., three) of the six flow paths, an outside-communicating portion 271 of the carriage-side connection part 220 is connected to the groove 260 and has a penetrating flow path 281 which passes through an end face 233. In this case, in the outside-communicating portions 271 of the carriage-side connection part 220, the groove 260, the sealing member 240 and the penetrating flow path 281 constitute the flow path.

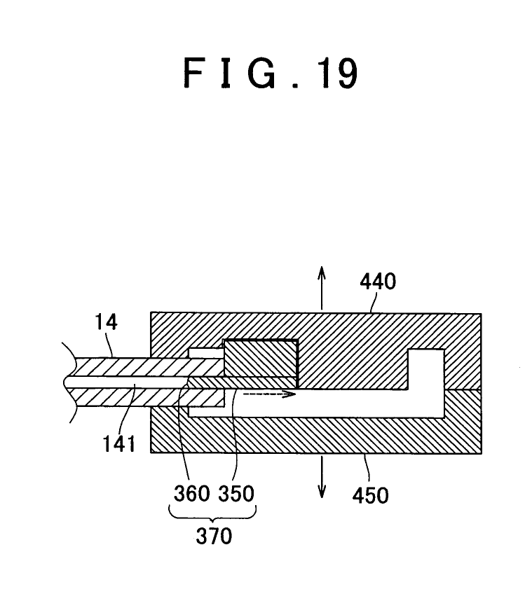

FIG. 19 is a schematic sectional view illustrating how to attach the carriage-side connection part 220 shown in FIG. 18 to the ink supplying tube 14. In FIG. 19, the parts corresponding to those of FIG. 15 are identified by the same reference numerals and a description of them is skipped.

When the carriage-side connection part 220 is attached to the ink supplying tube 14, the ink supplying tube 14 having two layers, that is, the inner layer portion 142 and the outer layer portion 144 is first formed by extrusion molding.

An upper die 440, a lower die 450 and a core 370 are prepared. The core 370 has a core body 350 constituting a part of the grooves 260 of the carriage-side connection part 220 and pins 360 which linearly extend from the core body 350. The pins 360 are substantially cylindrical in shape and the outside diameter of their sections is equal to or slightly larger than the inside diameter of the flow paths 141 of the ink supplying tube 14. When the core 370 is placed on the upper die 440, the top face and side face of the core 370 are brought into contact with the upper die 440, the side face being opposite to the side face at which the ink supplying tube 14 is placed. In this case, the pins 360 are inserted into their associated flow paths 141 from one end of the ink supplying tube 14.

In the state shown in FIG. 19, the carriage-side connection part 220 is outsert-molded by filling the space defined by the upper die 440 and the lower die 450 with resin. Then, the upper die 440 and the lower die 450 are separated from each other (in a vertical direction in the drawing), so that the carriage-side connection part 220 and the ink supplying tube 14 are removed. Further, the pins 360 of the core 370 are extracted from the ink supplying tube 14 (to the left in the drawing).

According to the attaching method of the present embodiment, when forming the carriage-side connection part 220 so as to enclose an end of the ink supplying tube 14, flow paths connected to the flow paths 141 of the ink supplying tube 14 can be formed in the carriage-side connection part 220, while preventing the resin from penetrating into the flow paths 141 of the ink supplying tube 14.

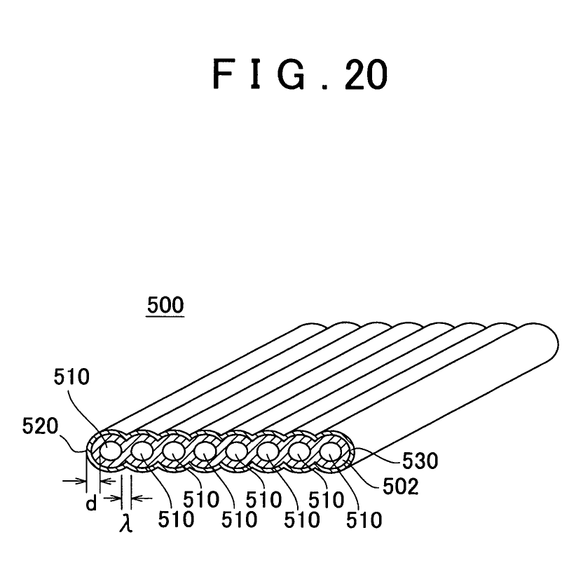

FIG. 20 is a perspective view of a liquid delivery tube 500 according to the present embodiment. For illustrative purposes, FIG. 20 shows a cut face of the tube 500 when cut in a direction perpendicular to a longitudinal direction. As shown in FIG. 20, the liquid delivery tube 500 is formed by extruding a resin having flexibility. The forming process will be described later. In the liquid delivery tube 500, a plurality of hollow flow paths 510 each defined by a resin 502 are arranged in parallel for allowing a fluid to flow therein. In the embodiment shown in FIG. 20, the plurality of flow paths 510 having substantially the same diameter are arranged in a straight line. The section of each flow path 510 when vertically cut in a direction perpendicular to the longitudinal direction is circular. Examples of the material of the flow paths 510 include polypropylene (PP), polyethylene (PE), olefin thermoplastic elastomer (TPE), styrene TPE, polyamide TPE and urethane TPE.

The liquid delivery tube 500 further includes a reinforcing layer 530 covering the outer circumferential surfaces of the flow paths 510. The reinforcing layer 530 is formed integrally with the flow paths 510 by a resin different from the resin 502. By covering the outermost side of the flow paths 510 with the reinforcing layer 530, the performance of the liquid delivery tube 500 can be enhanced.

The section of the outer circumferential surface 520 of the liquid delivery tube 500 when cut in a direction perpendicular to the longitudinal direction is in the form of a wave constituted by a series of circular arcs. In this liquid delivery tube 500, the thickness λ of the resin 502 existing between every adjacent flow paths 510 is equal to or less than the total thickness d of the resin 502 existing between the flow paths 510 and the outer circumferential surface 520 plus the reinforcing layer 530. More specifically, the liquid delivery tube 500 has a shorter distance and therefore a thinner resin between every adjacent flow paths 510, compared to the case where a plurality of cylindrical single tubes having thickness d are connected. For example, the inside diameter of the flow paths 510 is 1.5 mm, the thickness d is comparable to it, say, 1.5 mm, and the thickness λ of the resin between every adjacent flow paths 510 is 1.5 mm or less.

In the case of a specification in which evaporation from the liquid delivery tube 500 to the outside is inhibited, if the flow paths 510 of the liquid delivery tube 500 having less thickness d are filled with a liquid, vapors coming from the adjacent flow paths 510 offset each other. In addition, since the thickness of the resin existing between the adjacent flow paths 510 is equal to or less than the thickness d, the liquid delivery tube 500 can be miniaturized and bent in an arc having a small radius even though the plurality of flow paths 510 are arranged in parallel.

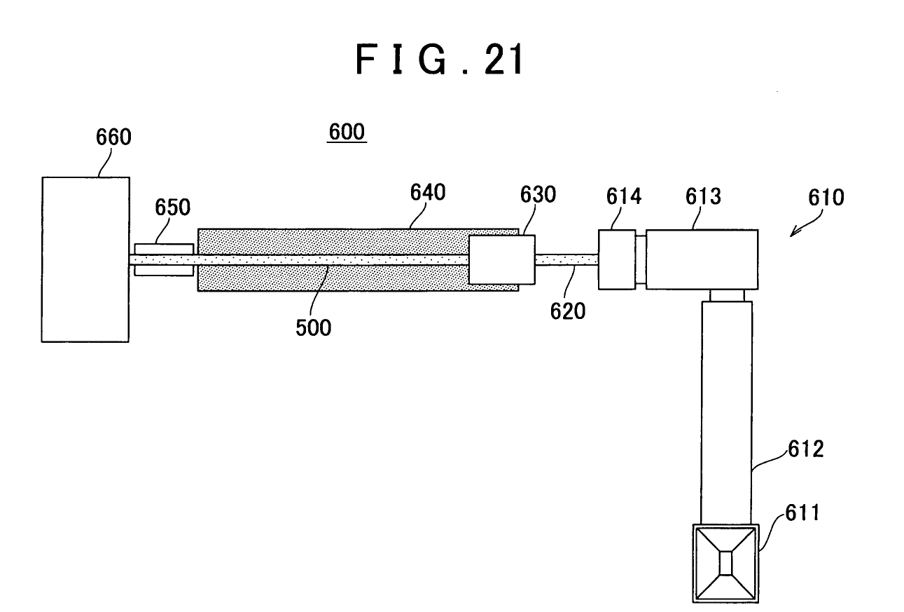

FIG. 21 is a schematic side view of a manufacturing apparatus 600 for producing the liquid delivery tube 500 shown in FIG. 20. The manufacturing apparatus 600 shown in FIG. 21 is equipped with an extrusion molding machine 610, a sizing system 630, a cooling water tank 640, a droplet remover 650, and a tube take-up device 660, these members being arranged in this order from the upstream side of the extruding direction of the liquid delivery tube 500. The extrusion molding machine 610 extrudes the resin 502 and the reinforcing layer 530, thereby forming an extruded tube 620 having the plurality of flow paths 510. For instance, the temperature of the resin is set to 170 to 240° C. and the speed of extrusion is set to 0.03 to 0.1 m/s, as molding conditions. The extruded tube 620, which has been molded and extruded, is pulled by the tube take-up device 660 and reshaped by the sizing system 630, thereby forming the liquid delivery tube 500. The reshaped liquid delivery tube 500 is cooled with water in the cooling water tank 640. The droplet remover 650 removes water droplets from the liquid delivery tube 500 thus cooled. The liquid delivery tube 500 from which water droplets have been removed is taken up by the tube take-up device 660.

The extrusion molding machine 610 includes: a hopper 611 loaded with the resin 502 and the resin for the reinforcing layer 530; a heating tube 612 for heating the resin 502 and the resin for the reinforcing 530 which have been poured into the hopper 611, so that they are brought into a molten state; an extrusion head portion 613 for extruding the molten resin 502 and the molten resin for the reinforcing layer 530 while changing the extruded resins from a cylindrical shape to a tubular shape; and an extrusion die portion 614 for forming the extruded tube 620 having the plurality of flow paths 510.

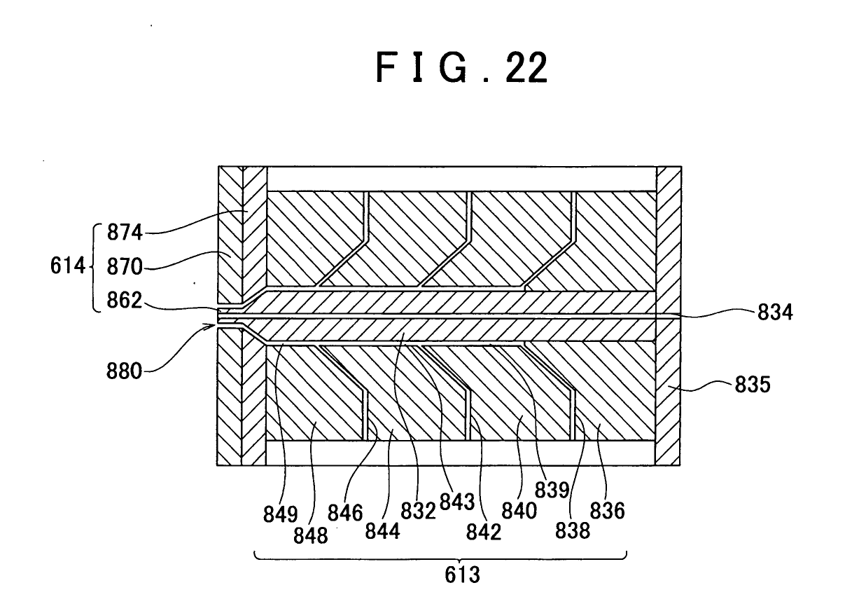

FIG. 22 is a sectional view of the extrusion head portion 613 and the extrusion die portion 614, when they are vertically cut in an extruding direction. As shown in FIG. 22, the extrusion head portion 613 has: a base plate 835; a cylindrical head core 832 attached to the base plate 835; a first head die 836 located at the rear end when viewed in the extruding direction; a second head die 840 located in front of the first head die 836; a third head die 844 located in front of the second head die 840; and a fourth head die 848 located in front of the third head die 848. Provided at the center of the head core 832 are gas flow paths 834 which communicate with the extrusion die portion 614 described later.

The first head die 836 is in the form of a cone having a through hole at its center and is attached to the head core 832 by inserting the rear end of the head core 832 into the through hole. The first head die 836 is attached to the head core 832 without a clearance between the first head die 836 and the head core 832.

The second head die 840 is disposed ahead of the first head die 836, with a first main body resin flow path 838 located between the first head die 836 and the second head die 840. The second head die 840 is funnel-like, having a through hole at its center. The head core 832 is inserted into the through hole of the second head die 840 with a resin flow path 839 located between the head core 832 and the second head die 840. Similarly, the funnel-like third head die 844 is disposed ahead of the first main body resin flow path 838, with a first main body resin flow path 842 located between the first main body resin flow path 838 and the third head die 844 and with a resin flow path 843 located between the head core 832 and the third head die 844. Further, the funnel-like fourth head die 848 is disposed ahead of the third head die 844, with a reinforcing resin flow path 846 located between the third head die 844 and the fourth head die 848 and with a resin flow path 849 located between the head core 832 and the fourth head die 848.

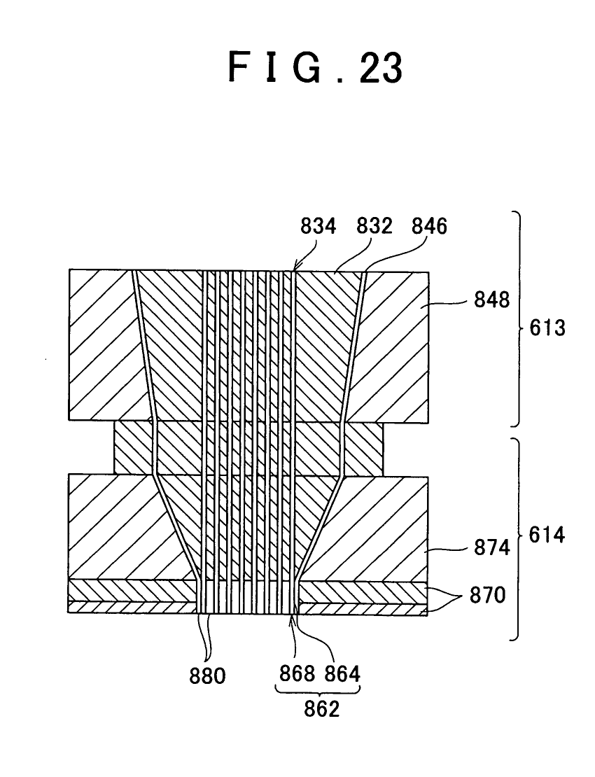

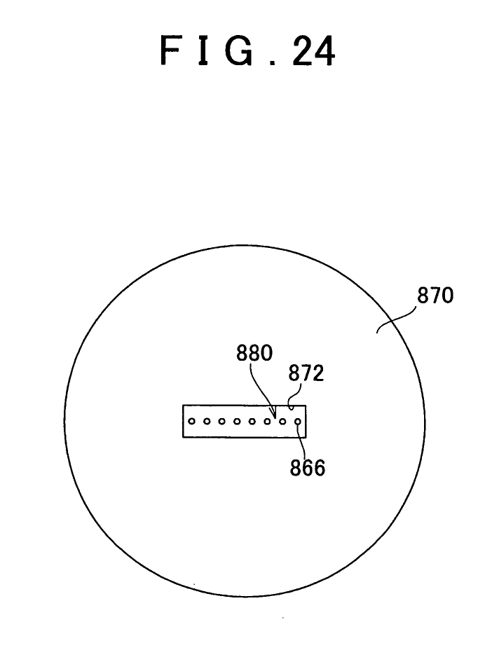

FIG. 23 is an enlarged sectional view wherein the extrusion head portion 613 and the extrusion die portion 614 are horizontally cut and the neighborhood of the extrusion die portion 614 is enlarged. FIG. 24 is an enlarged front elevational view showing the neighborhood of the extrusion die portion 614 when viewed from the downstream side.

As shown in FIGS. 23 and 24, the extrusion die portion 614 includes an extrusion core 862 which is formed integrally with the leading end of the head core 832 and is narrowed down at its leading end. The extrusion die portion 614 also includes a sheet-like extrusion die 870 and a draw die 874 which surround the extrusion core 862, with a resin flow path 880 located between the extrusion core 862 and the dies 870, 874. The extrusion core 862 has a plurality of tubular projections 864 which project downstream in the extruding direction. In the embodiment shown in FIG. 24, the same number (eight) of projections 864 as the number of the flow paths 510 of the liquid delivery tube 500 shown in FIG. 20 are arranged in a straight line. Gas flow paths 868 of the tubular projections 864 are connected to the gas flow paths 834 of the extrusion head portion 613. The eight projections 864 have the same outside diameter and the same inside diameter.

The extrusion die 870 is formed by stacking circular sheet-like members in the extruding direction, the sheet-like members including, at its center, a rectangular through hole having an inner circumference 872. In the extrusion die 870 shown in FIG. 23, two sheet-like members are stacked. Since the extrusion die 870 is thus formed by stacking a plurality of sheet-like members, the time required for processing the extrusion die 870 can be shortened and the extrusion die 870 can be easily replaced if the outer shape of the liquid delivery tube 500 is required to be changed. The inner circumference 872 is set to a larger size than the outer circumference of the liquid delivery tube 500.

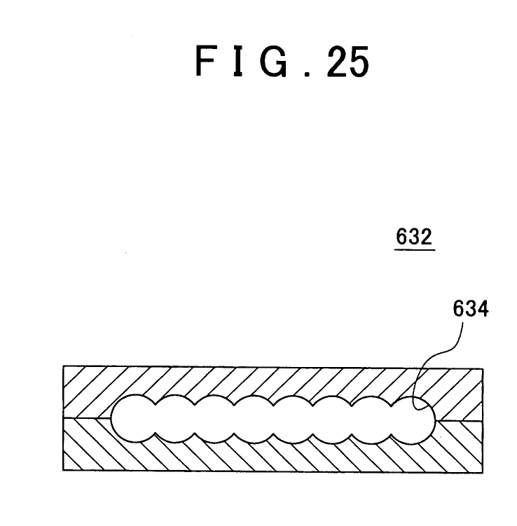

FIG. 25 is a sectional view of a sizing die 632 of the sizing system 630 when vertically cut in a longitudinal direction of the liquid delivery tube 500. The inner circumference 634 shown in FIG. 25 is composed of the inner circumferences of upper and lower dies. The inner circumference 634, that is, a combination of the inner circumferences of upper and lower dies, is set with such dimensional accuracy that the peripheral shape of the liquid delivery tube 500 and cooling contracture are taken into account. In correspondence with the shape of the liquid delivery tube 500 shown in FIG. 20, the inner circumference 634 of the sizing die 632 is determined such that the thickness λ of the resin 502 located between every adjacent flow paths 510 is equal to or less than the thickness d of the resin 502 located between each flow path 510 and the outer circumferential surface 520 plus the reinforcing layer 530.

The liquid delivery tube 500 is formed through the following steps by the extrusion molding machine 610 and the sizing system 630 of the above structure.

The hopper 611 of the extrusion molding machine 610 is loaded with the resin 502 and the resin for the reinforcing layer 530 which are in the form of pellets or flakes. In this case, two hoppers 611 are provided. One is loaded with the resin 502 and the other with the resin for the reinforcing layer 530. Then, the heating tube 612 gradually heats the resin 502 and the resin for the reinforcing layer 530, which have been poured in the hoppers 611, while delivering the resins, so that they are individually brought into the molten state. The heating tube 612 supplies the extrusion head portion 613 with the resins 502, 530 in the molten state. In this case, the heating tube 612 supplies the molten resin 502 to the first main body resin flow paths 838, 842, while supplying the molten resin for the reinforcing layer 530 to the reinforcing resin flow path 846.

In the extrusion head portion 613, the resin 502, which has been supplied to the first main body resin flow paths 838, 842, flows into the resin flow paths 839, 843, so that the extrusion head portion 613 forms the resin 502 into the shape of a cylinder having an inner circumferential shape corresponding to the peripheral shape of the head core 832. In the extrusion head portion 613, the resin for the reinforcing layer 530, which has been supplied to the reinforcing resin flow path 846 located in the downstream side of the first main body resin flow paths 838, 842, flows into the resin flow path 849, so that the reinforcing layer 530 is formed so as to cover the outer circumference of the resin 502 in cylindrical form. The first main body resin flow paths 838, 842 and the reinforcing resin flow path 846 are further supplied with the resin 502 and the resin for reinforcing layer 530, respectively, so that the resin 502 in cylindrical form and the reinforcing layer 530 are extruded to the downstream extrusion die potion 614.

The resin 502 in cylindrical form and the reinforcing layer 530, which have been pushed into the extrusion die portion 614, are forcibly moved along the outer circumference of the extrusion core 862 so that they are compressed into a shape of smaller diameter. Further, the flow paths 510 are formed by the projections 864 provided for the extrusion core 862. In this case, gas is naturally supplied to the gas flow paths 868 of the projections 864 through the gas flow paths 834 (the gas supplying step). While the gas flow paths 868 of the projections 864 are naturally supplied with gas, the resin 502 in cylindrical form and the reinforcing layer 530 flow into the resin flow paths 880 and are extruded, thereby forming the extruded tube 620 (the extrusion step). By this extrusion step, the inner circumferential shape of each flow path 510 of the extruded tube 620 is made coincident with the outer circumference 866 of the vertical section (with respect to the extruding direction) of each projection 864, and the peripheral shape of the extruded tube 620 is made coincident with the inner circumference 872 of the vertical section (with respect to the extruding direction) of the extrusion die 870. Thanks to the gas naturally supplied to the gas flow paths 868 of the projections 864 in the extrusion step, the interior of the flow paths 510 of the extruded tube 620 is prevented from coming into a vacuum state so that mutual adhesion of the inner faces and therefore crushing of the extruded tube 620 can be avoided to maintain the inside diameter of the flow paths 510.

The extruded tube 620 formed by the extrusion die portion 614 is elongated by the tube take-up device 660 through the sizing die 632 of the sizing system 630 and reshaped such that its contour matches the inner circumference 634 of the sizing die 632 (the sizing step). In this case, the gas flow paths 868 of the projections 864 of the extrusion die portion 614 are supplied with the gas, so that the flow paths 510 of the extruded tube 620 which is passing through the sizing die 632 of the sizing system 630 are also supplied with the gas. By applying gas pressure outwardly from the flow paths 510, the outer circumference of the extruded tube 620 is pressed against the inner circumference 634 of the sizing die 632, thereby carrying out stable reshaping. This sizing step may include a pressure reduction step for reducing the internal pressure of the sizing die 632. This makes it possible to more reliably press the outer circumference of the extruded tube 620 against the inner circumference 634 of the sizing die 632.

The extruded tube 620 is elongated through the sizing system 630, thereby reshaping the extruded tube 620 into the liquid delivery tube 500. The liquid delivery tube 500 thus reshaped is cooled by the cooling water tank 640 and taken up by the tube take-up device 660 as described earlier. Then, the liquid delivery tube 500 which has been taken up by the tube take-up device 660 up to a desired length is cut, creating an end face. The gas supplied to the flow paths 510 remains inside the tube or is naturally released to the air from the end face of the cut liquid delivery tube 500, the end face being located on the side of the extrusion molding machine 610. In this way, the liquid delivery tube 500 shown in FIG. 20 is produced.

According to the production method described above, after the extruded tube 620 is extruded by supplying gas from the projections 864 of the extrusion die portion 614 in the extrusion molding phase, reshaping of the contour of the tube 620 is carried out by similarly supplying gas from the projections 864 in the sizing die 632, thereby producing the liquid delivery tube 500. With this arrangement, the flow paths 510 can keep specified diameter without being squashed, so that the liquid delivery tube 500 having a desired outer shape can be stably produced.

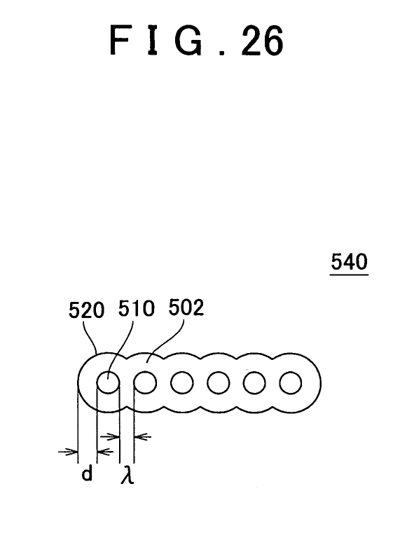

FIG. 26 is a sectional view of a liquid delivery tube 540 according to another example. Like the liquid delivery tube 500 shown in FIG. 20, the liquid delivery tube 540 shown in FIG. 26 is formed such that a plurality of flow paths 510 are arranged in a straight line, each flow path 510 having a circular section when cut in a direction perpendicular to a longitudinal direction thereof. Compared to the liquid delivery tube 500, the liquid delivery tube 540 has a shorter distance (i.e., a thinner resin 502) between every adjacent flow paths 510. In the liquid delivery tube 540, the thickness λ of the resin 502 existing between every adjacent flow paths 510 is equal to or less than the thickness d of the resin 502 existing between each flow path 510 and the outer circumferential surface 520. For example, the inside diameter of the flow paths 510 is 1.5 mm, the thickness d is comparable to the flow paths 510, say, 1.5 mm, and the thickness λ of the resin between the adjacent flow paths 510 is 1.5 mm or less. With this arrangement, the evaporation of the liquid from the liquid delivery tube 540 can be more reliably prevented. Like the outer circumferential surface 520 of the liquid delivery tube 500, the section of the outer circumferential surface 520 of the liquid delivery tube 540 when cut in a direction perpendicular to the longitudinal direction takes the form of a wave constituted by a series of circular arcs.

To produce the liquid delivery tube 540 shown in FIG. 26, the inner circumference 634 of the sizing die 632 shown in FIG. 25 is determined such that the thickness λ of the resin 502 located between the adjacent flow paths 510 is equal to or less than the thickness d of the resin 502 located between each flow path 510 and the outer circumferential surface 520 plus the reinforcing layer 530.

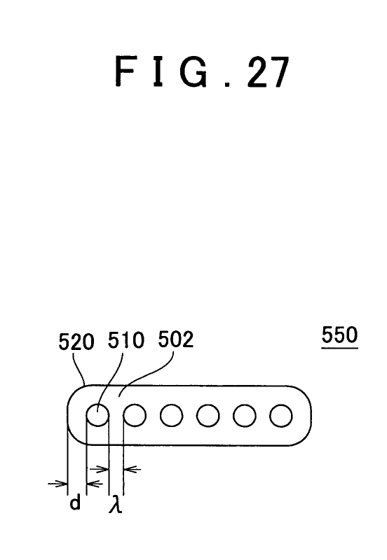

FIG. 27 is a sectional view of a liquid delivery tube 550 according to still another example. Like the liquid delivery tube 500 shown in FIG. 20, the liquid delivery tube 550 shown in FIG. 27 is formed such that a plurality of flow paths 510 are arranged in a straight line, each flow path 510 having a circular section when cut in a direction perpendicular to a longitudinal direction thereof. In the liquid delivery tube 550, the thickness λ of the resin 502 existing between every adjacent flow paths 510 is equal to or less than the thickness d of the resin 502 existing between each flow path 510 and the outer circumferential surface 520. For example, the inside diameter of the flow paths 510 is 1.5 mm, the thickness d is comparable to the flow paths 510, say, 1.6 mm, and the thickness λ of the resin between the adjacent flow paths 510 is 1.5 mm or less. With this arrangement, the evaporation of the liquid from the liquid delivery tube 550 can be more reliably prevented. The outer shape of the liquid delivery tube 550 differs from that of the liquid delivery tube 500 shown in FIG. 20. Specifically, the section of the liquid delivery tube 550 when cut in a direction perpendicular to the longitudinal direction is in the form of a rectangle rounded at its corners. Thanks to this arrangement, the flow paths 510 are made to be fur from the outside by the thicker resin 502 existing between each flow path 510 and the outer rim and, in consequence, the evaporation of the liquid from the liquid delivery tube 550 can be prevented.

For production of the liquid delivery tube 550 shown in FIG. 27, the inner circumference 634 of the sizing die 632 shown in FIG. 25 takes, in section, the form of a rectangle rounded at its four comers.

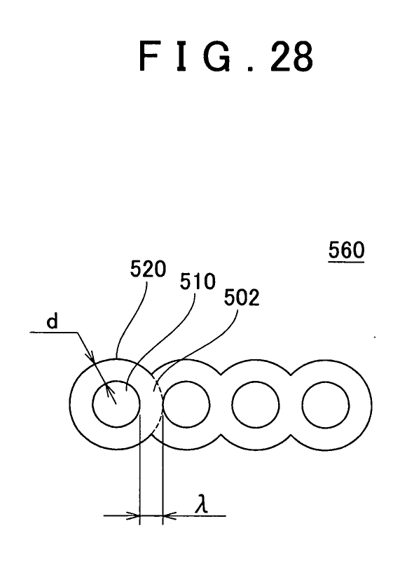

FIG. 28 is a sectional view of a liquid delivery tube 560 according to still another example. Like the liquid delivery tube 500 shown in FIG. 20, the liquid delivery tube 560 shown in FIG. 28 is formed such that eight flow paths 510 are arranged in a straight line, each flow path 510 having a circular section when cut in a direction perpendicular to a longitudinal direction thereof. In the liquid delivery tube 560, the thickness λ of the resin 502 existing between every adjacent flow paths 510 is substantially equal to the thickness d of the resin 502 existing between each flow path 510 and the outer circumferential surface 520. For example, the inside diameter of the flow paths 510 is 1.5 mm, and the thicknesses d and λ are comparable to the flow paths 510, say, 1.5 mm. Like the outer circumferential surface 520 of the liquid delivery tube 500, the section of the outer circumferential surface 520 of the liquid delivery tube 560 when cut in a direction perpendicular to the longitudinal direction takes the form of a wave constituted by a series of circular arcs.

Although the liquid delivery tubes 540, 550 and 560 shown in FIGS. 26 to 28 are formed from the resin 502, their outer circumferential surfaces 520 may be provided with the reinforcing layer 530, similarly to the liquid delivery tube 500 shown in FIG. 20.

Although the ink jet recording apparatus 1 has been described as an example of the liquid ejecting apparatus in the present embodiment, the liquid ejecting apparatus of the invention is not limited to this. Examples of the liquid ejecting apparatus include: color filter production systems for producing color filters for liquid crystal displays; electrode formation systems for forming electrodes for use in organic EL displays, FEDs (face emission displays) etc.; and biotip production systems for producing biotips. Also, examples of the liquid ejecting apparatus of the invention include other liquid ejecting apparatus intended for use in industrial applications. “The recording medium” means objects on which recording and printing are performed by emitting a jet of liquid, examples of which include recording paper, circuit boards on which circuit patterns such as electrodes for a display are printed, CD-ROMs having labels printed thereon, and preparation having DNA circuits printed thereon.

Although the present invention has been described by way of an exemplary embodiment, it should be understood that the technical scope of the invention is not limited to the embodiment and those skilled in the art might make many changes and substitutions without departing from the spirit and the scope of the present invention. It is obvious from the definition of the appended claims that embodiments with such modifications also belong to the scope of the present invention.

What is claimed is:

1. A method for attaching a connection part to at least one of both longitudinal ends of a liquid delivery tube having flexibility and including a flow path which extends between said longitudinal ends and through which a liquid flows, the method comprising the steps of:
preparing a pin having a leading end of substantially the same section as that of the flow path of the liquid delivery tube;
inserting the leading end portion of the pin into the flow path from at least one end of the liquid delivery tube;
placing dies so as to enclose said at least end of the liquid delivery tube through which the leading end portion of the pin is inserted;
forming the connection part by outsert molding from resin which fills the dies in which the liquid delivery tube and the pin are placed; and
extracting the pin from the liquid delivery tube after removal of the dies from the liquid delivery tube and the connection part.

2. The attaching method as claimed in claim 1, further including a melting-adhesion step in which after the extraction step, a sealing member is melted and adhered for sealing a hole through which the pin has been extracted, thereby forming a flow path in the connection part.

3. The attaching method as claimed in claim 1, further including an extrusion step in which the liquid delivery tube is formed by extrusion molding before the insertion step, the liquid delivery tube having a hollow inner layer portion which defines the flow path and an outer layer portion which has a melting point equal to or lower than that of the inner layer portion and covers the inner layer portion with the same material as contained in the connection part,
wherein, in the formation step, the outsert molding by use of the resin is carried out at a temperature equal to or lower than the melting point of the inner layer portion.

4. The attaching method as claimed in claim 1,
wherein the liquid delivery tube includes a plurality of said flow paths, and
wherein, in the preparation step, a coupling pin constituted by a plurality of said pins connected and arranged in parallel is prepared, and in the insertion step, the leading end portions of the plurality of pins which constitute the coupling pin are inserted into the flow paths, respectively, of the liquid delivery tube.

5. The attaching method as claimed in claim 1,
wherein the pin has an arcuate portion which curves in an arc from its leading end portion so as to have a substantially constant section, and
wherein the pin is extracted in a direction along the arcuate shape of the arcuate potion.

6. The attaching method as claimed in claim 1, wherein the liquid delivery tube is formed from a thermoplastic elastomer.

7. The attaching method as claimed in claim 6, wherein the liquid delivery tube is formed by extrusion molding.

8. The attaching method as claimed in claim 6 or 7, wherein the connection part is formed from polypropylene.

9. The attaching method as claimed in claim 6 or 7, wherein the connection part is formed from polyethylene.

10. The attaching method as claimed in claim 6 or 7, wherein the connection part is formed from a thermoplastic elastomer.

11. A liquid supplying member having: a liquid delivery tube having flexibility and including a flow path which extends between both longitudinal ends thereof and through which a liquid flows; and a connection part provided at at least one of said ends of the liquid delivery tube and having a flow path one end of which is coupled to the flow path of the liquid delivery tube while the other end being connected to the outside,
wherein the connection part has: an integral main body portion having a groove coupled, at one end, to the flow path of the liquid delivery tube and opened at one face thereof, and an outside-communicating portion which allows the other end of the groove to communicate with the outside; and a sealing member for sealing the open face of the groove, and
wherein the groove, the sealing member and the outside-communicating portion define the flow path of the connection part.

12. The liquid supplying member as claimed in claim 11, wherein the liquid delivery tube has a plurality of said flow paths and the connection part has the same number of flow paths as the liquid delivery tube has, the flow paths of the connection part being connected to the plurality of flow paths of the liquid delivery tube, respectively.

13. The liquid supplying member as claimed in claim 12,
wherein the outside-communicating portion of the connection part includes, in at least one of the plurality of flow paths, a penetrating flow path which is coupled to the other end of the groove and passes through the main body portion up to the rear of the open face of the groove, and
wherein the outside-communicating portions respectively includes, in the remaining ones of the plurality of flow paths, a coupling flow path for coupling the other end of the groove to the rear of the face in which the liquid delivery tube is disposed.

14. The liquid supplying member as claimed in claim 11,
wherein the liquid delivery tube includes a hollow inner layer portion defining the flow path; and an outer layer portion having a melting point equal to or lower than that of the inner layer portion and covering the inner layer portion with the same material as contained in the connection part.

15. The liquid supplying member as claimed in claim 11,
wherein the connection part further has a flow path for connecting the liquid delivery tube to the groove and said flow path curves in an arc.

16. The liquid supplying member as claimed in claim 11, wherein the liquid delivery tube is formed from a thermoplastic elastomer.

17. The liquid supplying member as claimed in claim 16, wherein the liquid delivery tube is formed by extrusion molding.

18. The liquid supplying member as claimed in claim 16 or 17, wherein the connection part is formed from polypropylene.

19. The liquid supplying member as claimed in claim 16 or 17, wherein the connection part is formed from polyethylene.

20. The liquid supplying member as claimed in claim 16 or 17, wherein the connection part is formed from a thermoplastic elastomer.

21. A liquid ejecting apparatus having: a liquid jet head for emitting a jet of liquid; liquid reservoir means for storing liquid; a liquid delivery tube having flexibility, for sending the liquid from the liquid reservoir means to the liquid jet head; and a connection part provided at at least one of both ends of the liquid delivery tube and having a flow path one end of which is coupled to a flow path of the liquid delivery tube while the other end being connected to the outside,
wherein the connection part has: (i) an integral main body portion including (1) a groove which communicates, at one end, with the flow path of the liquid delivery tube and is opened at one face, and (2) an outside-communicating portion for making the other end of the groove communicate with the outside; and (ii) a sealing member for sealing the open face of the groove, and
wherein the groove, the sealing member and the outside-communicating portion define the flow path of the connection part.

22. The liquid ejecting apparatus as claimed in claim 21,
wherein the connection part further has a flow path for connecting the liquid delivery tube to the groove and said flow path curves in an arc.

23. The liquid ejecting apparatus as claimed in claim 21, wherein the liquid delivery tube is formed from a thermoplastic elastomer.

24. The liquid ejecting apparatus as claimed in claim 23, wherein the liquid delivery tube is formed by extrusion molding.

25. The liquid ejecting apparatus as claimed in claim 23 or 24, wherein the connection part is formed from polypropylene.

26. The liquid ejecting apparatus as claimed in claim 23 or 24, wherein the connection part is formed from polyethylene.

27. The liquid ejecting apparatus as claimed in claim 23 or 24, wherein the connection part is formed from a thermoplastic elastomer.

28. A liquid supplying member having flexibility and including a flow path which extends between both longitudinal ends thereof and through which a liquid flows; and a connection part formed by outsert molding at at least one of said both ends of the liquid delivery tube and having a flow path one end of which is coupled to the flow path of the liquid delivery tube while the other end being connected to the outside,
wherein the liquid delivery tube includes: a hollow inner layer portion defining the flow path; and an outer layer portion which has a melting point equal to or lower than that of the inner layer portion and covers the inner layer portion with the same material as contained in the connection part.

29. The liquid supplying member as claimed in claim 28, wherein the liquid delivery tube has a plurality of said flow paths and the connection part has the same number of flow paths as the liquid delivery tube has, which are connected to the plurality of flow paths of the liquid delivery tube, respectively.

30. The liquid supplying member as claimed in claim 28, wherein the liquid delivery tube is formed from a thermoplastic elastomer.

31. The liquid supplying member as claimed in claim 30, wherein the liquid delivery tube is formed by extrusion molding.

32. The liquid supplying member as claimed in claim 30, wherein the connection part is formed from polypropylene.

33. The liquid supplying member as claimed in claim 30, wherein the connection part is formed from polyethylene.

34. The liquid supplying member as claimed in claim 30, wherein the connection part is formed from a thermoplastic elastomer.

35. A liquid delivery tube formed by extruding a resin having flexibility,
wherein a plurality of hollow flow paths defined by the resin are aligned in parallel, each allowing a fluid to flow therein, and
wherein the thickness of the resin between every adjacent flow paths is less than the thickness of the resin between each flow path and the outer circumferential surface of the resin.

36. The liquid delivery tube as claimed in claim 35, further comprising a reinforcing layer surrounding said outer circumferential surface, the reinforcing layer being made of a resin harder than said resin.

37. A method for producing a liquid delivery tube, the method comprising:
a gas supplying step in which gas is supplied to the inside of a plurality of tubular projections provided for an extrusion core;
an extrusion step in which an extruded tube is extruded by pouring a resin having flexibility into a resin flow path formed between the extrusion core and an extrusion die which surrounds the extrusion core, the extruded tube having flow paths each of which has an inner circumferential shape which coincides with the peripheral shape of each projection of the extrusion core in section perpendicular to an extruding direction, and the extruded tube having a peripheral shape which coincides with the inner circumferential shape of the extrusion die in section perpendicular to the extruding direction; and
a sizing step in which gas is supplied to the inside of the flow path of the extruded tube which has been extruded and the extruded tube is elongated by making the extruded tube pass through a sizing die which has a smaller inner circumference than the inner circumference of the extrusion die in section perpendicular to the extruding direction, whereby the liquid delivery tube is reshaped.

38. The method for producing a liquid delivery tube as claimed in claim 37,
wherein the sizing step includes a depressurization step for reducing pressure within the sizing die.

39. The method for producing a liquid delivery tube as claimed in claim 37,
wherein, in the inner circumference of the sizing die, the thickness of the resin between every adjacent flow paths is less than the thickness of the resin between each flow path and the outer circumferential surface of the liquid delivery tube.

40. The method for producing a liquid delivery tube as claimed in claim 37,
wherein the extrusion step includes a step in which a reinforcing layer enclosing the outer circumferential surface of the extruded tube is formed by pouring a reinforcing resin different from said resin from the downstream side of a position where said resin is poured, in the extruding direction.

41. The liquid delivery tube as claimed in claim 35, wherein the sectional area of the flow paths is 100 mm² or less per path.

42. The liquid delivery tube as claimed in claim 35, wherein a plurality of flow paths are arranged in parallel within said flow paths.
